(19) United States
(12) Patent Application Publication
(10) Pub. No.: US 2010/0128580 A1
(43) Pub. Date: May 27, 2010

(54) Optical Disc Apparatus and Focus Offset Control Method

(75) Inventors: Mayumi Sasaki, Fujisawa (JP); Tsuyoshi Toda, Kodaira (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi-LG Data Storage, Inc., Tokyo (JP)

(21) Appl. No.: 12/623,296

(22) Filed: Nov. 20, 2009

(30) Foreign Application Priority Data
Nov. 27, 2008 (JP) 2008-302616

(51) Int. Cl. G11B 7/00

(52) U.S. Cl. 369/44.11; G9B/7

(57) ABSTRACT

An optical disc apparatus in which processing time is shortened and processing accuracy is ensured upon focus offset processing for plural recording layers. Regarding each of mutually adjacent recording layers, based on a signal based on reflected light from a guide groove formed in a recording surface of the recording layer, a focus offset for an optical system with respect to the guide groove is learned, and based on the learned focus offsets for the respective recording layers, a focus offset for recording or reproduction is calculated and set. In an optical disc having three or more recording layers, a focus offset when the difference between the focus offset and the learned focus offsets for the respective recording layers is a value corresponding to the characteristic of the optical system is set as a focus offset for the respective recording layers or a common focus offset to the respective recording layers. Otherwise, a mean value of the focus offsets when the differences between the focus offsets and the learned focus offsets for the respective recording layers are values corresponding to the characteristic of the optical system is set as a focus offset for one recording layer.

### INFORMATION BY REFERENCE

The present application claims priority from Japanese application JP2008-302616 filed on Nov. 27, 2008, the entire content of which is hereby incorporated by reference into this application.

### BACKGROUND

The present invention relates to a focus offset processing in an optical disc apparatus, and more particularly, when an optical disc has plural recording layers, to a focus offset setting for the plural recording layers.

As conventional techniques related to the present invention, Japanese Patent No. 3465413 (Patent Document 1), Japanese Patent Publication No. 2003-217140 (Patent Document 2) and Japanese Patent Publication No. 2003-248940 (Patent Document 3) are known. Japanese Patent No. 3465413 discloses a technique of setting a focus offset value using a tracking error signal amplitude, jitter, an RF signal amplitude and the like. Japanese Patent Publication No. 2003-217140 discloses a technique of independently setting a focus offset for respective recording layers. Japanese Patent Publication No. 2003-248940 discloses a technique of providing a temperature detector in an apparatus, and when an internal temperature of the apparatus has changed by a predetermined or greater value and when focus jump or seek has been completed, performing offset readjustment.

### SUMMARY

In the above-described related techniques, as focus offset amounts for respective recording layers are independently obtained or a focus offset amount after recording layer change is obtained based on differences in tracking error signal amplitude, jitter, an RF signal amplitude and the like between statuses before and after the recording layer change, time required for offset processing is long. Further, in the case of an unrecorded state recording layer, processing accuracy may not be ensured.

The present invention has an object to, in view of the situations of the above-described conventional techniques, in an optical apparatus, upon focus offset processing for plural recording layers, to reduce the processing time and ensure the accuracy in the focus offset processing for a recording layer in recorded status (including a reproduction-only disc) and a recording layer in unrecorded status. Further, another object of the present invention is to ensure the accuracy in the focus offset processing in correspondence with temperature change in the apparatus.

The purpose of the present invention is to attain the above-described objects and provide a technique for improvement in usability in an optical disc apparatus.

To attain the above-described objects, the present invention provides an optical disc apparatus in which, regarding each of mutually adjacent recording layers among plural recording layers in an optical disc, based on a signal corresponding to reflected light from a guide groove formed in a recording surface of the recording layer, a focus offset for an optical system with respect to the guide groove is learned, and based on the learned focus offsets for the respective recording layers, a focus offset for recording or reproduction is calculated and set. As the focus offset for recording or reproduction, a mean value of the above-described learned focus offsets for the respective recording layers is set as a common focus offset to the respective recording layers. Otherwise, a focus offset when a difference between the focus offset and the above-described learned focus offsets for the respective recording layers is a value corresponding to the characteristic of the above-described optical system is set as a focus offset for the respective recording layers or as a common focus offset to the respective recording layers. Otherwise, a mean value of focus offsets when a difference between the focus offset and the learned focus offsets for the respective recording layers is a value corresponding to the characteristic of the above-described optical system is set as a focus offset for one recording layer. Further, in correspondence with temperature change in the apparatus, a mean value of the above-described learned focus offsets for the respective recording layers or a focus offset when a difference between the focus offset and the learned focus offsets for the respective recording layers is a value corresponding to the characteristic of the above-described optical system is set as a focus offset for the optical system for recording or reproduction.

Note that in the present invention, the focus offset obtained by the above-described learning means a focus offset within an appropriate range in the present invention. Further, the “recording layer” in the present invention means a layer in which information is recorded (recording layer), and includes a recording layer in which information is already recorded (including a recording layer of a reproduction-only disc and a recording layer of a recordable disc i.e. a rewritable or write-once-read-many disc) and a recording layer in which information is not recorded yet but will be recorded (in this case, a recording layer of a recordable disc).

According to the present invention, in an optical disc apparatus, focus offset processing for plural recording layers can be performed in short time, and information recording or a reproduction operation can be quickly started. Further, the accuracy can be ensured in focus offset processing for a recording layer in recorded status (including a reproduction-only disc) and a recording layer in unrecorded status. Further, the accuracy in focus offset processing can be ensured in correspondence with temperature change in the apparatus.

### BRIEF DESCRIPTION OF THE DRAWINGS

These and other features, objects and advantages of the present invention will become more apparent from the following description when taken in conjunction with the accompanying drawings wherein:

FIG. 1 is a block diagram of an optical disc device in a first embodiment of the present invention;

FIG. 2 illustrates positions of reference surfaces of plural recording layers of an optical disc and positions of an optical system in an optical pickup, in the optical disc device in FIG. 1;

FIG. 3 is a graph explaining focus offset learning and focus offset setting for recording or reproduction in the optical disc device in FIG. 1;

FIG. 4 is a graph explaining the focus offset learning and the focus offset setting for recording or reproduction in the optical disc device in FIG. 1 based on measured data;

FIG. 5 is a graph explaining the focus offset learning and the focus offset setting for recording or reproduction in the optical disc device in FIG. 1 based on other measured data;

FIG. 6 is a flowchart showing the operation of focus offset processing by the optical disc device in FIG. 1 for adjacent recording layers in the optical disc.

FIG. 7 is a graph explaining the focus offset setting for an optical disc having three or more recording layers in the optical disc device in FIG. 1;

FIG. 8 is a flowchart showing the operation of the focus offset processing in FIG. 7;

FIG. 9 is a graph explaining other focus offset processing for the optical disc having three or more recording layers in the optical disc device in FIG. 1;

FIG. 10 is a flowchart showing the operation of the focus offset processing in FIG. 9;

FIG. 11 is a block diagram of the optical disc device in a second embodiment of the present invention;

FIG. 12 is a graph showing an example of the temperature characteristic of focus offset for the optical system; and

FIG. 13 is a graph showing a status when the temperature characteristic in FIG. 12 is improved by using the optical disc apparatus in FIG. 11.

### DETAILED DESCRIPTION OF PREFERRED EMBODIMENTS

Hereinbelow, embodiments of the present invention will be described using the drawings.

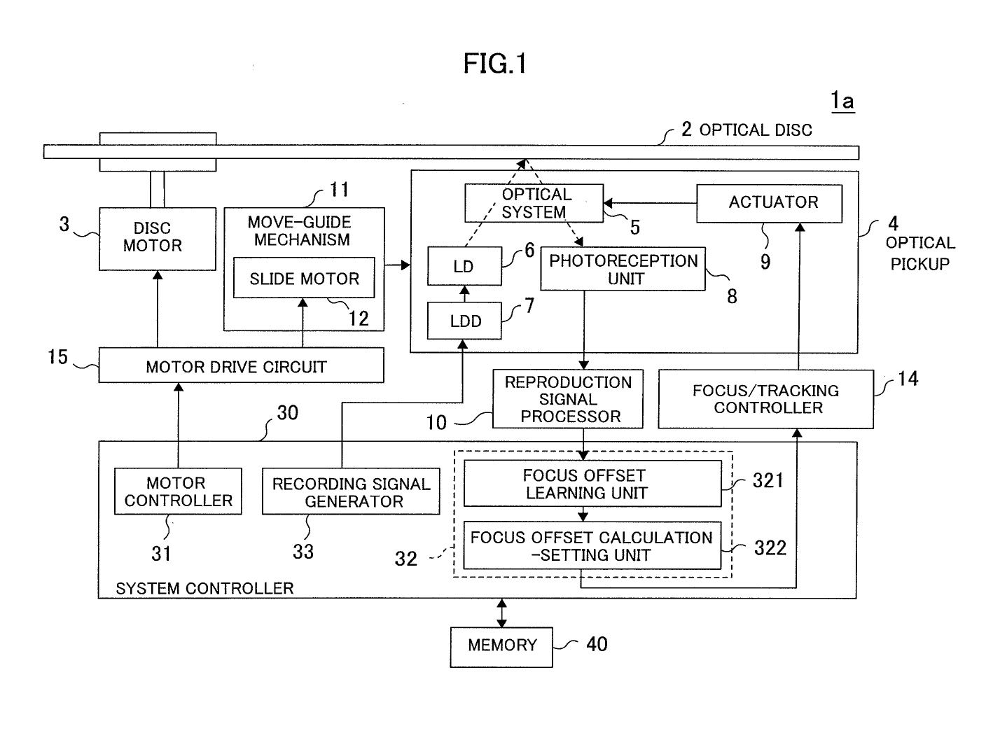

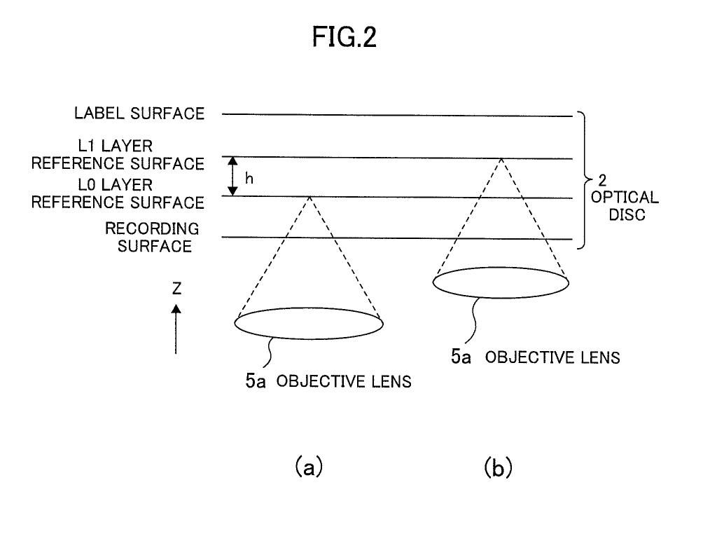

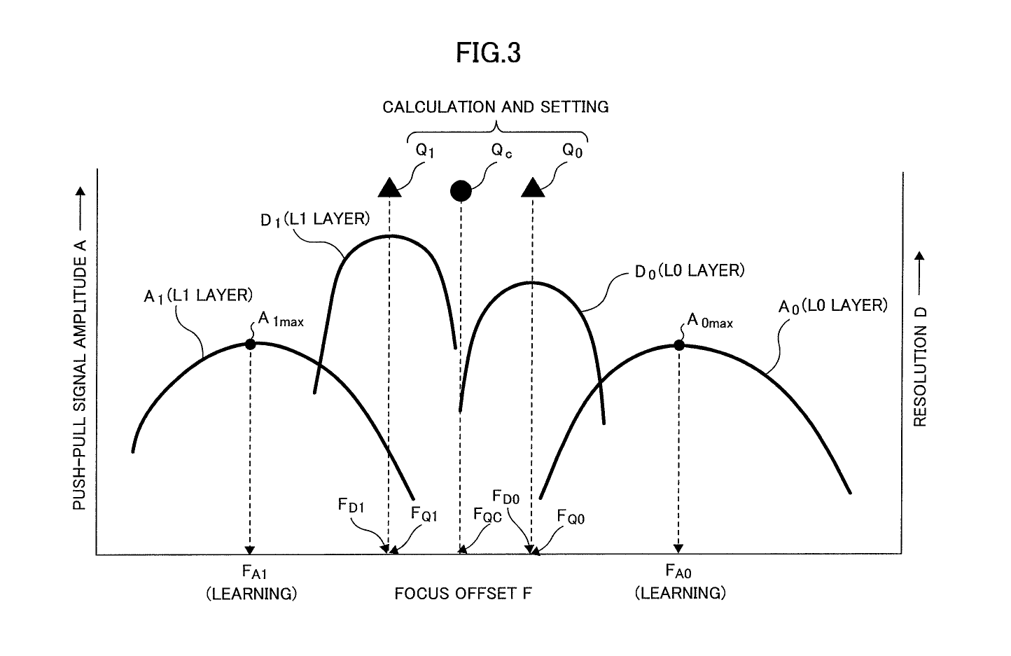

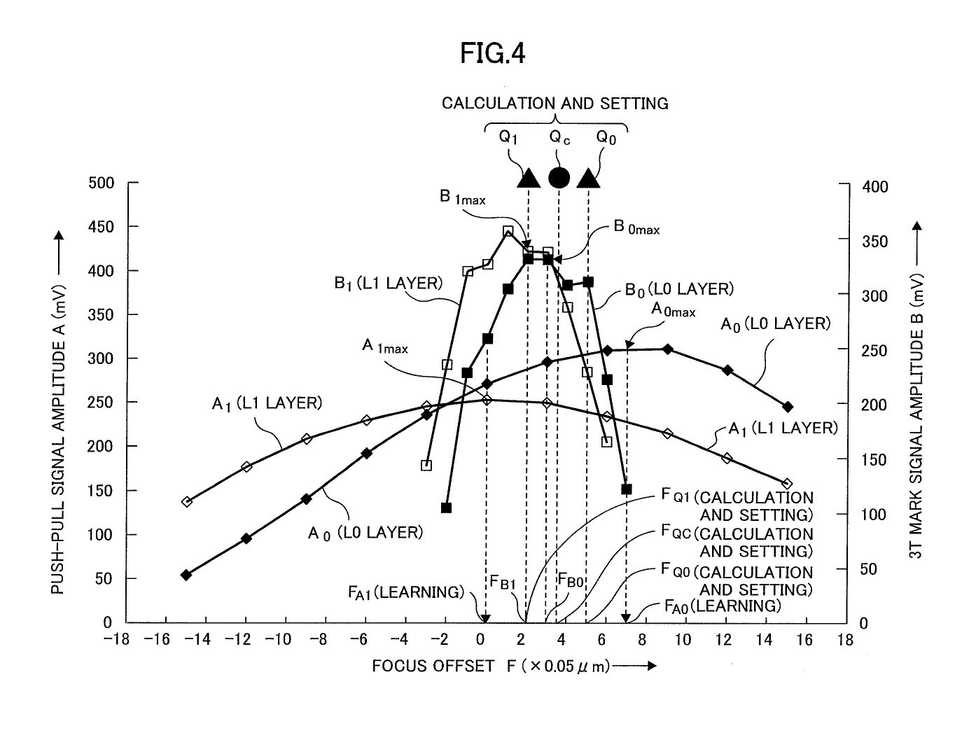

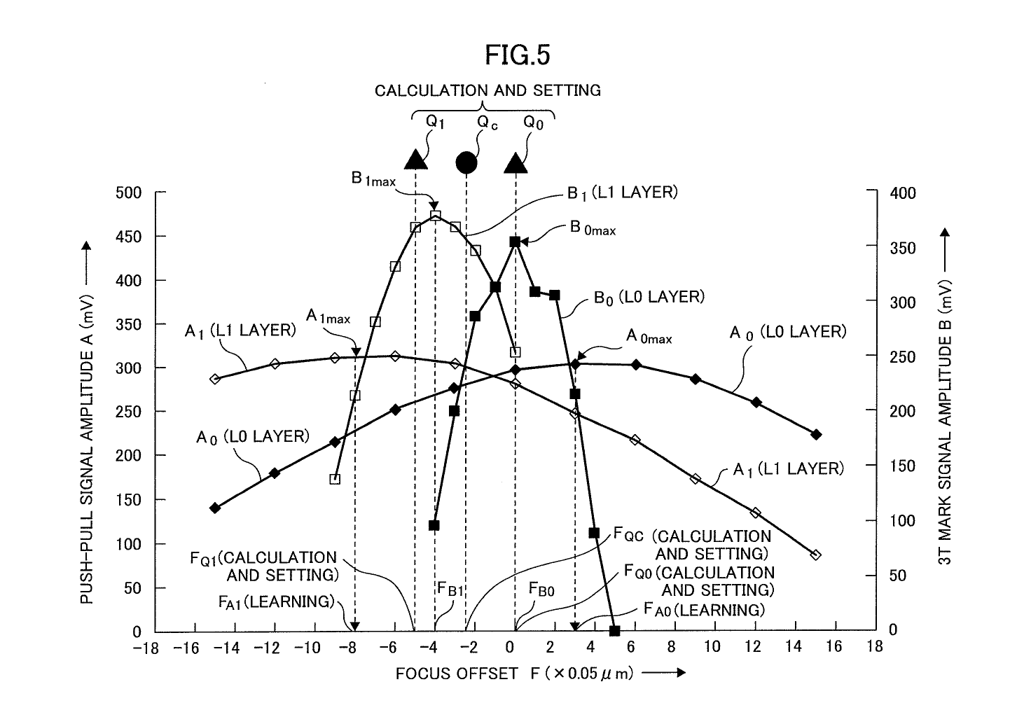

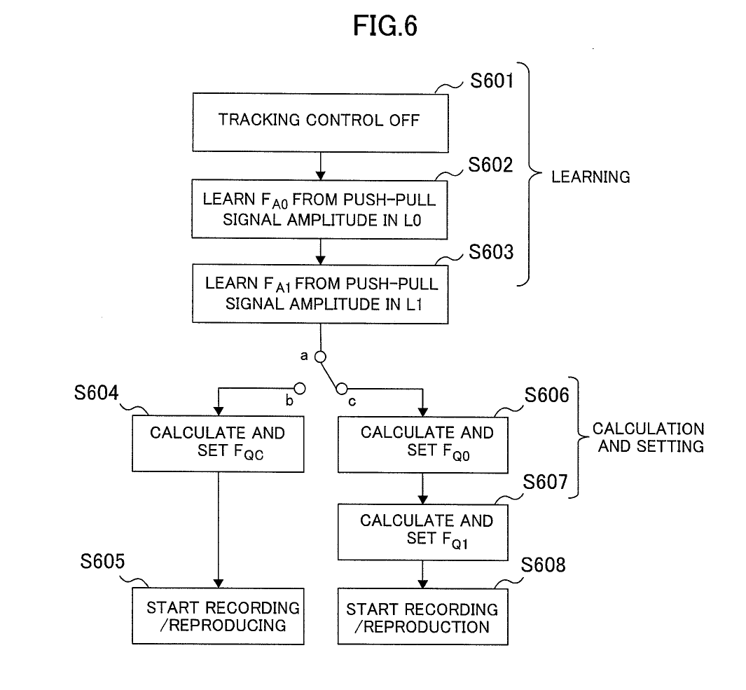

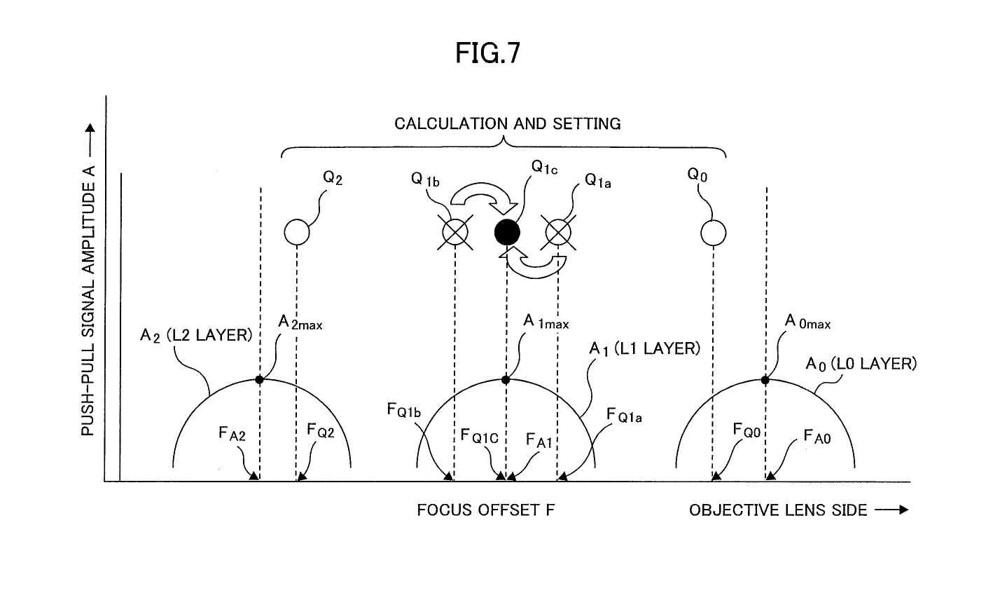

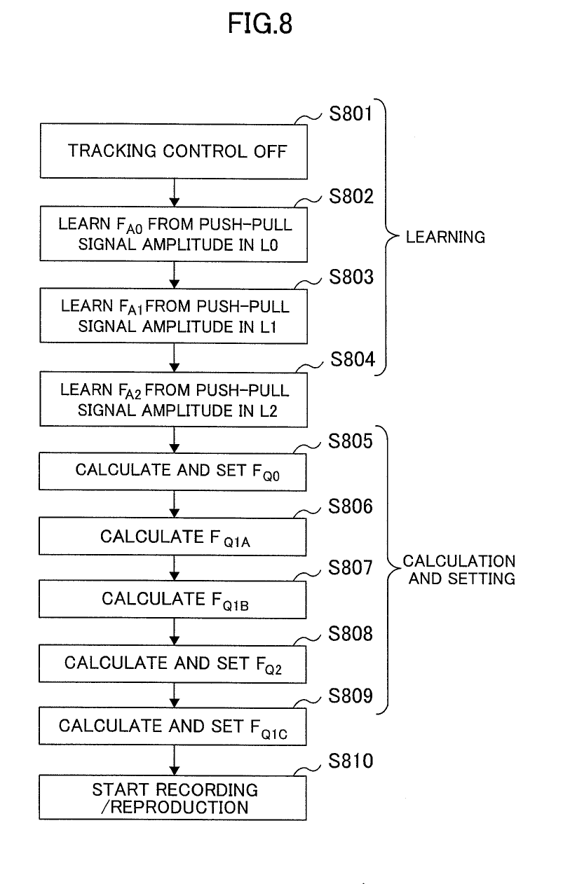

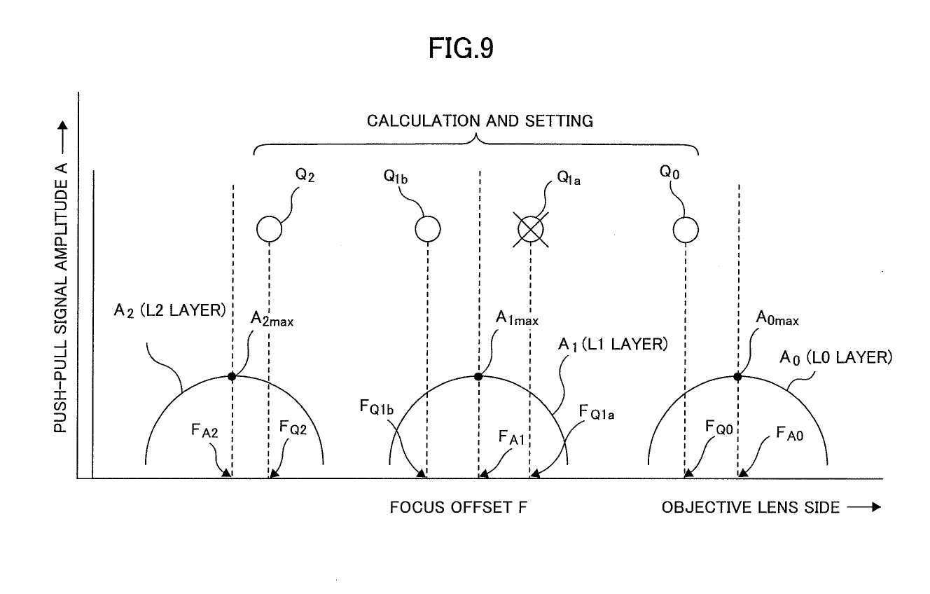

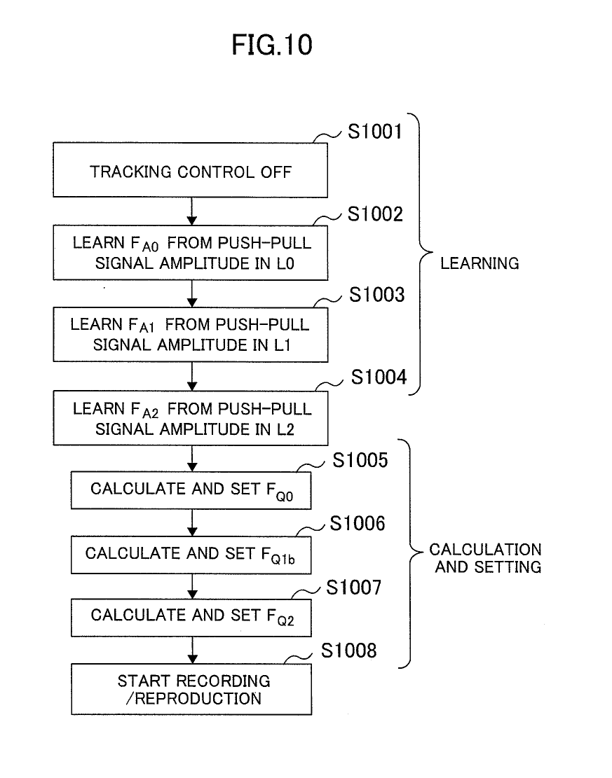

FIGS. 1 to 10 are used for explanation of an optical disc device in a first embodiment of the present invention. FIG. 1 is a block diagram of the optical disc device in the first embodiment of the present invention; FIG. 2 illustrates positions of reference surfaces of plural recording layers of an optical disc and positions of an optical system in an optical pickup, in the optical disc device in FIG. 1; FIG. 3 is a graph explaining focus offset learning and focus offset setting for recording or reproduction in the optical disc device in FIG. 1; FIG. 4 is a graph explaining the focus offset learning and the focus offset setting for recording or reproduction in the optical disc device in FIG. 1 based on measured data; FIG. 5 is a graph explaining the focus offset learning and the focus offset setting for recording or reproduction in the optical disc device in FIG. 1 based on other measured data; FIG. 6 is a flowchart showing the operation of focus offset processing by the optical disc device in FIG. 1 for adjacent recording layers in the optical disc. FIG. 7 is a graph explaining the focus offset setting for an optical disc having three or more recording layers in the optical disc device in FIG. 1; FIG. 8 is a flowchart showing the operation of the focus offset processing in FIG. 7; FIG. 9 is a graph explaining other focus offset processing for an optical disc having three or more recording layers in the optical disc device in FIG. 1; and FIG. 10 is a flowchart showing the operation of the focus offset processing in FIG. 9.

Note that the “recording layer” used in the following description means a layer in which information is recorded (recording layer), and includes a recording layer in which information is already recorded (including a recording layer of a reproduction-only disc and a recording layer of a recordable disc) and a recording layer in which information is not recorded yet but will be recorded (in this case, a recording layer of a recordable disc).

In FIG. 1, reference numeral 1a denotes an optical disc device in the embodiment; 2, an optical disc such as a DVD+/−R DL having plural recording layers; 3, a disc motor to rotate-drive the optical disc 2; 4, an optical pickup; 5, an optical system including an objective lens (not shown), provided in the optical pickup 4, to collect laser light and emit the collected laser light on a recording surface of the optical disc 2; 6, a laser diode provided in the optical pickup 4, to generate laser light in predetermined intensity for recording or reproduction; 7, a laser drive circuit provided in the optical pickup 4, to drive the laser diode 6; 8, a photoreception unit provided in the optical pickup 4, to receive reflected light from the recording surface (disc surface) of the optical disc 2 via the optical system 5, convert the received light into an electric signal (reproduction signal) and output the signal; 9, an actuator to change the position and attitude of the objective lens (not shown) in the optical system 5; 10, a reproduction signal processor to perform signal processing on the reproduction signal outputted from the photoreception unit 8, as an RF signal, by performing amplification, demodulation and the like; 11, a move-guide mechanism having a linear guide member (not shown), a lead screw member (not shown) and the like to move the optical pickup 4 in an approximately radial direction of the optical disc 2; 12, a slide motor provided in the move-guide mechanism 11, to rotate-drive the lead screw member (not shown); 14, a focus/tracking controller to generate a drive signal to drive the actuator 9; 15, a motor drive circuit to rotate-drive the disc motor 3 and the slide motor 12; 30, a system controller as a controller to control the entire optical disc device 1a; 31, a motor controller provided in the system controller 30, to control the motor drive circuit 15; 32, a microcomputer in the system controller 30; 321, a focus offset learning unit as a first controller provided in the microcomputer 32, to learn (detect) an optimum focus offset (a focus offset within an optimum range i.e. a focus offset within an appropriate range in the present invention. In the following description, all the “optimum focus offset” mean this focus offset) of the optical system 5 from a signal outputted from the reproduction signal processor 10; and 322, a focus offset calculation-setting unit as a second controller provided in the microcomputer 32, to calculate and set a focus offset for the optical system 5 for recording or reproduction based on the optimum focus offset learned by the focus offset learning unit 321. Upon learning of the optimum focus offset, based on the signal outputted from the reproduction signal processor 10, i.e., a signal based on reflected light from a guide groove formed in respective recording surfaces of mutually adjacent recording layers among plural recording layers of the optical disc 2, the focus offset learning unit 321 as the first controller learns (detects) the optimum focus offset for the optical system 5 with respect to respective guide grooves.

Further, in FIG. 1, numeral 33 denotes a recording signal generator to generate and output a recording signal to drive the laser diode 6; and 40, a memory holding characteristic information of the optical system 5, information on the optimum focus offset for respective adjacent recording layers learned by the focus offset learning unit 321, information on the focus offset for the optical system 5 for recording or reproduction calculated and set by the focus offset calculation-setting unit 322, a program to cause the focus offset learning unit 321 to execute a series of procedures of learning operation, a program to cause the focus offset calculation-setting unit 322 to execute a series of procedures of the above-described calculation-setting operation, and the like. The characteristic information of the optical system 5, the program for execution of the learning operation, and the program for execution of the calculation and setting operation are previously stored in the memory 40 prior to the optimum focus offset learning operation by the focus offset learning unit 321.

Upon optical focus offset learning, as a signal based on the reflected light from the guide groove formed in the recording surfaces of mutually adjacent plural recording layers, a push-pull signal or a wobble signal is outputted from the reproduction signal processor 10.

Upon optimum focus offset learning, the focus offset learning unit 321 as the first controller uses the push-pull signal or the wobble signal outputted from the reproduction signal processor 10, and learns (detects) focus offsets when the amplitude of the push-pull signal or the wobble signal is maximum (a value within a substantially maximum range, i.e., a value within a range including a true maximum value and e.g. 95% of the true maximum value. Hereinbelow, “maximum” or “maximum value” in the amplitude of the push-pull signal or the wobble signal has this meaning) as respective optimum focus offsets with respect to the respective guide grooves of the mutually adjacent plural recording layers. When the optimum focus offset is learned from the push-pull signal, tracking control is turned off (OFF). When the optimum focus offset is learned from the wobble signal, the tracking control is turned on (ON). The focus offset learning unit 321 performs predetermined procedures in the optimum focus offset learning operation in accordance with the program read from the memory 40.

When the focus offset calculation-setting unit 322 as the second controller calculates and sets a focus offset for information recording or reproduction with respect to mutually adjacent plural recording layers, the focus offset calculation-setting unit 322 calculates a mean value of respective optimum focus offsets of the adjacent plural recording layers i.e. focus offsets when the amplitude of the above-described push-pull signal or the wobble signal is maximum (mean focus offset), learned by the focus offset learning unit 321, and sets the calculated mean value as a common focus offset to the both recording layers upon recording or reproduction. Otherwise, the focus offset calculation-setting unit 322 calculates a focus offset when the difference between the focus offset and the optimum focus offsets of the respective recording layers learned by the focus offset learning unit 321 is a value corresponding to the characteristic of the optical system 5 i.e. a focus offset weighted by recording layer in correspondence with the characteristic of the optical system 5, and individually sets the calculated focus offset by recording layer as a focus offset for recording or reproduction in the above-described mutually adjacent plural recording layers.

When the above-described mean focus offset for recording or reproduction is calculated and set using the result of learning by the focus offset learning unit 321, the focus offset calculation-setting unit 322 sets the focus offset as follows. That is, for example, when a first recording layer (L0 layer) and a second recording layer (L1 layer) are arranged from the laser light incident side (the side on which the optical system 5 is provided), and F_{A0} is obtained as a focus offset when the amplitude of the push-pull signal or the wobble signal is maximum by learning by the focus offset learning unit 321 with respect to the first recording layer (L0 layer) and F_{A1} is obtained as a focus offset when the amplitude of the push-pull signal or the wobble signal is maximum by learning with respect to the second recording layer (L1 layer), a value as a focus offset F_{QC} for recording or reproduction in the first recording layer (L0 layer) and the second recording layer (L1 layer), calculated by, e.g.,

F_{QC}=(F_{A0}+F_{A1})/2 (Expression 1)

is set as a common focus offset (focus offset for recording or reproduction) to the first recording layer (L0 layer) and the second recording layer (L1 layer).

Further, when a focus offset for recording or reproduction is calculated and set individually for the adjacent recording layers using the result of learning by the focus offset learning unit 321 and in correspondence with the characteristic of the optical system 5, the focus offset calculation-setting unit 322 sets the focus offset for recording or reproduction as follows. That is, for example, when a first recording layer (L0 layer) and a second recording layer (L1 layer) are arranged from the laser light incident side, and F_{A0} is obtained as a focus offset when the amplitude of the push-pull signal or the wobble signal is maximum by learning by the focus offset learning unit 321 with respect to the first recording layer (L0 layer) and F_{A1} is obtained as a focus offset when the amplitude of the push-pull signal or the wobble signal is maximum by learning with respect to the second recording layer (L1 layer), a value as the focus offset F_{Q0} for recording or reproduction in the first recording layer (L0 layer) calculated by, e.g.,

F_{Q0}=(3×F_{A0}+F_{A1})/4 (Expression 2)

is set.

Further, as the focus offset F_{Q1} for recording or reproduction in the second recording layer (L1 layer), a value calculated by, e.g.,

F_{Q1}=(F_{A0}−3×F_{A1})/4 (Expression 3)

is set.

The focus offset calculation-setting unit 322 performs the operation procedures to calculate and set the above-described focus offset for the optical system 5 for recording or reproduction in accordance with the program read from the memory 40.

Note that the above-described expressions 1 to 3 are expressions obtained by an experiment using plural optical discs by the present inventor in the progress of study of the present invention, and are practical expressions to solve the problems of the present invention and obtain remarkable advantages.

In the optical disc device 1a having the above-described configuration, upon information recording or reproduction with respect to the optical disc 2 having plural recording layers, e.g. in a status where the optical disc 2 is loaded in the device and rotated at a predetermined speed, laser light generated by the laser diode 6 in the optical pickup 4 is emitted on recording surfaces of the plural recording layers of the optical disc 2 through the optical system 5, and focus offset processing for the plural recording layers is performed. The focus offset processing is performed by utilizing groove information on a guide groove (information on structure and status of the groove) formed in the respective recording layers, for mutually adjacent recording layers. That is, regarding the mutually adjacent recording layers, reflected light from the guide groove formed in the recording surface of the recording layer is received by the photoreception unit 8 then converted to an electric signal (reproduction signal), and outputted from the reproduction signal processor 10 as a push-pull signal or a wobble signal. When it is arranged such that a push-pull signal is outputted from the reproduction signal processor 10 upon focus offset processing, tracking control is not performed in the optical disc device 1a, and only a focus control signal is outputted from the focus/tracking controller 14. On the other hand, when it is arranged such that a wobble signal is outputted from the reproduction signal processor 10, the tracking control is also performed, and focus control signal and tracking control signal are outputted from the focus/tracking controller 14. The push-pull signal or the wobble signal outputted from the reproduction signal processor 10 as groove information on the guide groove of the mutually adjacent respective recording layers is inputted into the focus offset learning unit 321 in the microcomputer 32. The focus offset learning unit 321 learns (detects) a focus offset when the amplitude of the inputted push-pull signal or wobble signal is maximum as an optimum focus offset, for the mutually adjacent respective recording layers. The focus offset calculation-setting unit 322 in the microcomputer 32 calculates a mean value of the optimum focus offsets for the mutually adjacent recording layers learned by the focus offset learning unit 321 or a focus offset when the difference between the focus offset and the learned respective optimum focus offsets is a value corresponding to the characteristic of the optical system 5, as described above, and sets the calculated focus offset as a focus offset for the above-described optical system for recording or reproduction.

Hereinbelow, the constituent elements of the optical disc device 1a in FIG. 1 used in the following description have the same reference numerals in FIG. 1.

FIG. 2 illustrates positions of reference surface (surface where the focus offset is 0 (zero)) of plural recording layers of the optical disc 2 and corresponding positions of the optical system 5 in the optical pickup 4 in the optical disc device 1a in FIG. 1. In FIG. 2, (a) shows a status where laser light collected with the optical system 5 is emitted on the first recording layer (L0 layer) and learning of optimum focus offset for the first recording layer (L0 layer) is performed from a push-pull signal or a wobble signal based on reflected light from the guide groove of the recording surface of the first recording layer (L0). In FIG. 2, (b) shows a status where the laser light collected with the optical system 5 is emitted on the second recording layer (L1 layer) adjacent to the above-described first recording layer (L0 layer) and learning of optimum focus offset for the second recording layer (L1 layer) is performed from a push-pull signal or a wobble signal based on reflected light from the guide groove of the recording surface of the second recording layer (L1). Numeral 5a denotes an objective lens in the optical system 5, and h, a distance between the reference surface of the first recording layer (L0 layer) and the reference surface of the second recording layer (L1 layer). Upon learning of optimum focus offset, the position of the objective lens 5a in a focus direction (±Z axis direction) is controlled by the actuator 9 based on the focus control signal from the focus/tracking controller 14. When learning of optimum focus offset for the first recording layer (L0 layer) is performed, the position of the objective lens 5a in the focus direction is changed by the actuator 9 in the vicinity of the reference surface of the first recording layer (L0 layer) including the reference surface position of the first recording layer (L0 layer), and a focus offset by the objective lens 5a in the position in the focus direction when the amplitude of the push-pull signal or the wobble signal is maximum is learned by the focus offset learning unit 321 as an optimum focus offset for the first recording layer (L0 layer). Similarly, when learning of optimum focus offset for the second recording layer (L1 layer) is performed, the position of the objective lens 5a in the focus direction is changed by the actuator 9 in the vicinity of the reference surface of the second recording layer (L1 layer) including the reference surface position of the second recording layer (L1 layer), and a focus offset by the objective lens 5a in the position in the focus direction when the amplitude of the push-pull signal or the wobble signal is maximum is learned by the focus offset learning unit 321 as an optimum focus offset for the second recording layer (L1 layer). An optimum focus offset for the third recording layer (L2 layer) (not shown) is similarly learned.

In the following explanation, the first recording layer (L0 layer) and the second recording layer (L1 layer) are in the positional relation shown in the FIG. 2 with respect to the laser light incident direction (direction in which the objective lens 5a is provided). Further, in the case of the optical disc where the recording layer has three or more layers described in FIGS. 7 to 10, a third recording layer (L2 layer) (not shown) is arranged in a position further on the z-axial directional side from the second recording layer (L1 layer).

FIG. 3 is a graph explaining focus offset learning and focus offset setting for recording or reproduction with respect to the optical disc 2 in the optical disc device 1a in FIG. 1. In FIG. 3, the focus offset learning is performed using a push-pull signal. In FIG. 3, a horizontal axis indicates a focus offset F, and a vertical axis, a push-pull signal amplitude A and a resolution D.

In FIG. 3, reference numeral A₀ denotes a model of an amplitude characteristic curve of the push-pull signal outputted from the reproduction signal processor 10 based on reflected light from the guide groove of the first recording layer (L0 layer); A₀ₘₐₓ, a maximum value on the amplitude characteristic curve A0 i.e. a maximum value of the push-pull signal amplitude regarding the first recording layer (L0 layer); F_{A0}, a focus offset when the push-pull signal amplitude is the maximum value A₀ₘₐₓ on the amplitude characteristic curve A₀ i.e. an optimum focus offset; A₁, a model of an amplitude characteristic curve of the push-pull signal outputted from the reproduction signal processor 10 based on reflected light from the guide groove of the second recording layer (L1 layer); A₁ₘₐₓ, a maximum value on the amplitude characteristic curve A₁ i.e. a maximum value of the push-pull signal amplitude regarding the second recording layer (L1 layer); F_{A1}, a focus offset when the push-pull signal amplitude is the maximum value A₁ₘₐₓ on the amplitude characteristic curve A₁ i.e. an optimum focus offset; D₀, a model of a resolution characteristic curve based on the reflected light from the first recording layer (L0 layer); F_{D0}, a focus offset when the resolution characteristic curve D₀ is a maximum value; D₁, a model of a resolution characteristic curve based on the reflected light from the second recording layer (L1 layer); and F_{D1}, a focus offset when the resolution characteristic curve D₁ is a maximum value. The above-described maximum value A₀ₘₐₓ of the push-pull signal amplitude and the focus offset F_{A0} at that time (optimum focus offset) and above-described maximum value A₁ₘₐₓ of the push-pull signal amplitude and the focus offset F_{A1} at that time (optimum focus offset) are learned (detected) by the focus offset learning unit 321 as the first controller. Note that the above-described resolution D is defined with a ratio of the amplitude of the signal based on the reflected light from a shortest mark (3T mark in a DVD) in the guide groove in the respective recording layers of the optical disc 2 to the amplitude of the signal based on the reflected light from a longest mark (11T mark in a DVD) in the guide groove in the respective recording layers of the optical disc 2.

Further, in FIG. 3, numeral Q₀ denotes the position of a focus offset calculated and set by the focus offset calculation-setting unit 322 based on the above-described focus offsets (optimum focus offsets) F_{A0} and F_{A1} such that the difference between the focus offset and the focus offset F_{A0} is a value corresponding to the characteristic of the optical system 5, i.e., the position of a focus offset weighted to the focus offset F_{A0} side in correspondence with the characteristic of the optical system 5 (i.e., the difference from the focus offset F_{A0} is smaller than the difference from the focus offset F_{A1}); F_{Q0}, a focus offset corresponding to the position Q₀; Q₁, the position of a focus offset calculated and set by the focus offset calculation-setting unit 322 based on the above-described focus offsets F_{A0} and F_{A1} such that the difference between the focus offset and the focus offset F_{A1} is a value corresponding to the characteristic of the optical system 5, i.e., the position of a focus offset weighted to the focus offset F_{A1} side in correspondence with the characteristic of the optical system 5 (i.e., the difference from the focus offset F_{A1} is smaller than the difference from the focus offset F_{A0}); F_{Q1}, a focus offset corresponding to the position Q₁; Q_{C}, the position of a focus offset calculated and set by the focus offset calculation setting unit 322 based on the above-described focus offsets F_{A0} and F_{A1} as a mean value focus offset of the both focus offsets F_{A0} and F_{A1}; and F_{QC}, a focus offset corresponding to the position Q_{c}. FIG. 3 shows a case where the accuracy of an expression used in focus offset calculation by the focus offset calculation-setting unit 322 is high, the focus offset F_{Q0} calculated and set by the focus offset calculation-setting unit 322 and the focus offset F_{D0} when the resolution characteristic curve D₀ is a maximum value are the same, and the focus offset F_{Q1} calculated and set by the focus offset calculation-setting unit 322 and the focus offset F_{D1} when the resolution characteristic curve D₁ is a maximum value are the same. The focus offset F_{QC} is calculated by using e.g. the expression 1, the focus offset F_{Q0} is calculated by using e.g. the expression 2, and the focus offset F_{Q1} is calculated by using e.g. the expression 3. The respective focus offsets F_{QC}, F_{Q0} and F_{Q1} are set as focus offsets for information recording or reproduction without obtaining the resolution characteristic curves D₀, D₁ and the focus offsets F_{D0} and F_{D1}.

Note that on the horizontal axis in FIG. 3, the position of the focus offset F=0 in the first recording layer (L0 layer) and the position of the focus offset F=0 in the second recording layer (L1 layer) are overlapped each other. That is, in FIG. 3, the above-described both positions are overlapped each other assuming that the distance h in FIG. 2 is 0 (zero).

FIG. 4 is a graph explaining the focus offset learning and the focus offset setting for information recording or reproduction in the optical disc device 1a in FIG. 1 based on measured data, in which a horizontal axis indicates the focus offset F, and a vertical axis, the push-pull signal amplitude A and amplitude B of the signal regarding the 3T mark. In FIG. 4, the result of learning using the push-pull signal by the focus offset learning unit 321 is used. The focus offset calculation-setting unit 322 calculates a mean value of optimum focus offsets obtained by the learning (focus offsets within optimum ranges i.e. focus offsets within appropriate ranges in the present invention), and sets the calculated focus offset as a focus offset for recording or reproduction. Further, the focus offset calculation-setting unit 322 obtains a focus offset when the difference between the focus offset and the optimum focus offsets obtained by the above-described learning is a value corresponding to the characteristic of the optical system 5 i.e. a focus offset weighted in correspondence with the characteristic of the optical system 5, by calculation, and sets the obtained focus offset as a focus offset for recording or reproduction.

In FIG. 4, numeral A₀ denotes a measured amplitude characteristic curve of the push-pull signal outputted from the reproduction signal processor 10 based on reflected light from the guide groove of the first recording layer (L0 layer); A₀ₘₐₓ, an amplitude value learned by the focus offset learning unit 321 as a maximum value on the measured amplitude characteristic curve A₀ i.e. a maximum value (a maximum value obtained by polynomial expression using measured data) of the push-pull signal amplitude regarding the first recording layer (L0 layer); F_{A0}, a focus offset learned by the focus offset learning unit 321 as a focus offset when the push-pull signal amplitude is maximum on the measured amplitude characteristic curve A₀ i.e. an optimum focus offset. Further, numeral A₁ denotes a measured amplitude characteristic curve of the push-pull signal outputted from the reproduction signal processor 10 based on reflected light from the guide groove of the second recording layer (L1 layer); A₁ₘₐₓ, an amplitude value learned by the focus offset learning unit 321 as a maximum value on the measured amplitude characteristic curve A₁ i.e. a maximum value (a maximum value obtained by polynomial expression using measured data) of the push-pull signal amplitude regarding the second recording layer (L1 layer); and F_{A1}, a focus offset learned by the focus offset learning unit 321 as a focus offset when the push-pull signal amplitude is maximum on the measured amplitude characteristic curve A₁ i.e. an optimum focus offset.

Further, in FIG. 4, numeral B₀ denotes a measured amplitude characteristic curve of a signal outputted from the reproduction signal processor 10 based on reflected light from the 3T mark in the guide groove of the first recording layer (L0 layer); F_{B0}, a focus offset when the measured amplitude characteristic curve B₀ is a maximum value B₀ₘₐₓ (a maximum value obtained by polynomial expression using measured data). Further, numeral B1 denotes a measured amplitude characteristic curve of a signal outputted from the reproduction signal processor 10 based on reflected light from the 3T mark in the guide groove of the second recording layer (L1 layer); F_{B1}, a focus offset when the measured amplitude characteristic curve B₁ is a maximum value B1max (a maximum value obtained by polynomial expression using measured data).

Further, in FIG. 4, numeral Q₀ denotes the position of a focus offset calculated and set by the focus offset calculation-setting unit 322 based on the above-described focus offsets (optimum focus offsets) F_{A0} and F_{A1} using the above-described expression 2 such that the difference between the focus offset and the focus offset F_{A0} is a value corresponding to the characteristic of the optical system 5 i.e. the position of a focus offset weighted to the focus offset F_{A0} side in correspondence with the characteristic of the optical system 5 (i.e., the difference from the focus offset F_{A0} is smaller than the difference from the focus offset F_{A1}); and F_{Q0}, a focus offset corresponding to the position Q₀. Further, numeral Q₁ denotes the position of a focus offset calculated and set by the focus offset calculation-setting unit 322 based on the above-described learned focus offsets F_{A0} and F_{A1} using the above-described expression 3 such that the difference between the focus offset and the focus offset F_{A1} is a value corresponding to the characteristic of the optical system 5 i.e. the position of a focus offset weighted to the focus offset F_{A1} side in correspondence with the characteristic of the optical system 5 (i.e., the difference from the focus offset F_{A1} is smaller than the difference from the focus offset F_{A0}); and F_{Q1}, a focus offset corresponding to the position Q₁. Further, numeral Q_{C} denotes the position of a focus offset calculated and set by the focus offset calculation setting unit 322 based on the above-described learned focus offsets F_{A0} and F_{A1} using the above-described expression 1 as a mean value focus offset of the both focus offsets F_{A0} and F_{A1}; and F_{QC}, a focus offset corresponding to the position Q_{c}.

Note that in FIG. 4, on the horizontal axis, the position of the focus offset F=0 in the first recording layer (L0 layer) and the position of the focus offset F=0 in the second recording layer (L1 layer) are overlapped each other. That is, the above-described both positions are overlapped each other assuming that the distance h in FIG. 2 is 0 (zero).

More particularly, in FIG. 4, the optimum focus offset F_{A0} for the first recording layer (L0 layer) learned by the focus offset learning unit 321 is about 7×0.05 μm, and the optimum focus offset F_{A1} for the second recording layer (L1 layer), about 0×0.05 μm. Further, the focus offset F_{B0} when the measured amplitude characteristic curve B₀ is the maximum value B₀ₘₐₓ is about 3×0.05 μm, and the focus offset F_{B1} when the measured amplitude characteristic curve B₁ is the maximum value B₁ₘₐₓ, about 2×0.05 μm. Further, the focus offset F_{Q0}, calculated and set by the focus offset calculation-setting unit 322 based on the above-described learned optimum focus offsets F_{A0} and F_{A1} and in correspondence with the characteristic of the optical system 5 as a focus offset for recording or reproduction in the first recording layer (L0 layer), is about 5×0.05 μm; the focus offset F_{Q1} calculated and set as a focus offset for recording or reproduction in the second recording layer (L1 layer) is about 2×0.05 μm; and the focus offset F_{QC}, calculated and set as a mean value of the both focus offsets F_{A0} and F_{A1} as a focus offset for recording or reproduction common to the first recording layer (L0 layer) and the second recording layer (L1 layer), is about 3.5×0.05 μm.

As it is apparent from the above description, the focus offset F_{Q0} (about 5×0.05 μm) set as a focus offset for recording or reproduction in the first recording layer (L0 layer) is a value close to the focus offset F_{B0} (about 3×0.05 μm) when the measured amplitude characteristic curve B₀ of the first recording layer (L0 layer) is the maximum value B₀ₘₐₓ. Further, the focus offset F_{Q1} (about 2×0.05 μm) set as a focus offset for recording or reproduction in the second recording layer (L1 layer) corresponds with the focus offset F_{B1} (about 2×0.05 μm) when the measured amplitude characteristic curve B₁ of the second recording layer (L1 layer) is the maximum value B₁ₘₐₓ. Further, the mean value focus offset F_{QC} (about 3.5×0.05 μm) set as a common focus offset for recording or reproduction to the first recording layer (L0 layer) and the second recording layer (L1 layer) is a value close to the above-described measured focus offset F_{B0} (about 3×0.05 μm) and the above-described measured focus offset F_{B1} (about 2×0.05 μm). As a result, in an optical disc where mutually adjacent recording layers respectively have push-pull signal characteristic and signal amplitude characteristic regarding the 3T mark as shown in FIG. 4, it may be arranged in the optical disc device 1a such that as a focus offset for recording or reproduction, the mean value focus offset of the above-described learned optimum focus offsets F_{A0} and F_{A1} common to the first recording layer (L0 layer) and the second recording layer (L1 layer) is calculated and set based on the expression 1. Otherwise, it may be arranged such that focus offsets corresponding to the respective first recording layer (L0 layer) and the second recording layer (L1 layer) are calculated and set using the expressions 2 and 3.

FIG. 5 is a graph explaining the focus offset learning and the focus offset setting for recording or reproduction in the optical disc device 1a in FIG. 1 based on measured data having a push-pull signal amplitude characteristic different from that in FIG. 4, regarding the optical disc 4, for which mutually adjacent recording layers are different from these in FIG. 4. As in the case of FIG. 4, in FIG. 5, the horizontal axis indicates the focus offset F, and the vertical axis, the push-pull signal amplitude A and the amplitude B regarding the 3T mark. In FIG. 5, the result of learning by the focus offset learning unit 321 using the push-pull signal is used, the focus offset calculation-setting unit 322 calculates a mean value of optimum focus offsets obtained by the learning, and sets the calculated focus offset as a focus offset for information recording or reproduction, or obtains a focus offset when the difference between the focus offset and the optimum focus offset obtained by the above-described learning is a value corresponding to the characteristic of the optical system 5 i.e. a focus offset weighted in correspondence with the characteristic of the optical system 5, by calculation, and sets the obtained focus offset as a focus offset for information recording or reproduction.

In FIG. 5, numeral A₀ denotes a measured amplitude characteristic curve of the push-pull signal outputted from the reproduction signal processor 10 based on reflected light from the guide groove of the first recording layer (L0 layer); A₀ₘₐₓ, an amplitude value learned by the focus offset learning unit 321 as a maximum value on the amplitude characteristic curve A₀ i.e. a maximum value (a maximum value obtained by polynomial expression using measured data) of the push-pull signal amplitude regarding the first recording layer (L0 layer); and F_{A0}, a focus offset learned by the focus offset learning unit 321 as a focus offset when the push-pull signal amplitude is maximum on the measured amplitude characteristic curve A₀ i.e. an optimum focus offset. Further, numeral A₁ denotes a measured amplitude characteristic curve of the push-pull signal outputted from the reproduction signal processor 10 based on reflected light from the guide groove of the second recording layer (L1 layer); A₁ₘₐₓ, an amplitude value learned by the focus offset learning unit 321 as a maximum value on the measured amplitude characteristic curve A₁ i.e. a maximum value (a maximum value obtained by polynomial expression using measured data) of the push-pull signal amplitude regarding the second recording layer (L1 layer); and F_{A1}, a focus offset learned by the focus offset learning unit 321 as a focus offset when the push-pull signal amplitude is maximum on the measured amplitude characteristic curve A₁ i.e. an optimum focus offset.

Further, in FIG. 5, numeral B₀ denotes a measured amplitude characteristic curve of a signal outputted from the reproduction signal processor 10 based on reflected light from the 3T mark in the guide groove of the first recording layer (L0 layer); and F_{B0}, a focus offset when the measured amplitude characteristic curve B₀ is a maximum value B₀ₘₐₓ (a maximum value obtained by polynomial expression using measured data). Further, numeral B₁ denotes a measured amplitude characteristic curve of a signal outputted from the reproduction signal processor 10 based on reflected light from the 3T mark in the guide groove of the second recording layer (L1 layer); and F_{B1}, a focus offset when the measured amplitude characteristic curve B₁ is a maximum value B₁ₘₐₓ (a maximum value obtained by polynomial expression using measured data).

Further, in FIG. 5, numeral Q₀ denotes the position of a focus offset calculated and set by the focus offset calculation-setting unit 322 based on the above-described focus offsets (optimum focus offsets) F_{A0} and F_{A1} using the above-described expression 2 such that the difference between the focus offset and the focus offset F_{A0} is a value corresponding to the characteristic of the optical system 5, i.e., the position of a focus offset weighted to the focus offset F_{A0} side in correspondence with the characteristic of the optical system 5 (i.e., the difference from the focus offset F_{A0} is smaller than the difference from the focus offset F_{A0}; and F_{Q0}, a focus offset corresponding to the position Q₀. Further, numeral Q₁ denotes the position of a focus offset calculated and set by the focus offset calculation-setting unit 322 based on the above-described focus offsets F_{A0} and F_{A1} using the above-described expression 3 such that the difference between the focus offset and the focus offset F_{A1} is a value corresponding to the characteristic of the optical system 5, i.e., the position of a focus offset weighted to the focus offset F_{A1} side in correspondence with the characteristic of the optical system 5 (i.e., the difference from the focus offset F_{A1} is smaller than the difference from the focus offset F_{A0}); and F_{Q1}, a focus offset corresponding to the position Q₁. Further, numeral Q_{C} denotes the position of a focus offset calculated and set by the focus offset calculation setting unit 322 based on the above-described focus offsets F_{A0} and F_{A1} using the above-described expression 1 as a mean value focus offset of the both focus offsets F_{A0} and F_{A1}; and F_{QC}, a focus offset corresponding to the position Q_{C}.

Note that in FIG. 5, as in the case of FIG. 4, on the horizontal axis, the position of the focus offset F=0 in the first recording layer (L0 layer) and the position of the focus offset F=0 in the second recording layer (L1 layer) are overlapped each other. That is, in FIG. 5, the above-described both positions are overlapped each other assuming that the distance h in FIG. 2 is 0 (zero).

More particularly, in FIG. 5, the optimum focus offset F_{A0} for the first recording layer (L0 layer) learned by the focus offset learning unit 321 is about 3×0.05 μm, and the optimum focus offset F_{A1} for the second recording layer (L1 layer), about −8×0.05 μm. Further, the focus offset F_{B0} when the measured amplitude characteristic curve B₀ is the maximum value B₀ₘₐₓ is about 0×0.05 μm, and the focus offset F_{B1} when the measured amplitude characteristic curve B₁ is the maximum value B₁ₘₐₓ, about −4×0.05 μm. Further, the focus offset F_{Q0}, calculated and set by the focus offset calculation-setting unit 322 based on the above-described learned optimum focus offsets F_{A0} and F_{A1} and in correspondence with the characteristic of the optical system 5 as a focus offset for recording or reproduction in the first recording layer (L0 layer), is about 0×0.05 μm; the focus offset F_{Q1} calculated and set as a focus offset for recording or reproduction in the second recording layer (L1 layer) is about −5×0.05 μm; and the focus offset F_{QC}, calculated and set as a mean value of the both focus offsets F_{A0} and F_{A1} as a focus offset for recording or reproduction common to the first recording layer (L0 layer) and the second recording layer (L1 layer), is about −2.5×0.05 μm.

As it is apparent from the above description, the focus offset F_{Q0} (about 0×0.05 μm) set as a focus offset for recording or reproduction in the first recording layer (L0 layer) approximately corresponds with the focus offset F_{B0} (about 0×0.05 μm) when the measured amplitude characteristic curve B₀ of the first recording layer (L0 layer) is the maximum value B₀ₘₐₓ. Further, the focus offset F_{Q1} (about −5×0.05 μm) set as a focus offset for recording or reproduction in the second recording layer (L1 layer) is a value close to the focus offset F_{B1} (about −4×0.05 μm) when the measured amplitude characteristic curve B₁ of the second recording layer (L1 layer) is the maximum value B₁ₘₐₓ. However, the difference between the mean value focus offset F_{QC} (about −2.5×0.05 μm), set as a common focus offset for recording or reproduction to the first recording layer (L0 layer) and the second recording layer (L1 layer), and the above-described measured focus offset F_{B0} (about 0×0.05 μm) and the above-described measured focus offset F_{B1} (about −4×0.05 μm) is large. As a result, in an optical disc where mutually adjacent recording layers respectively have push-pull signal characteristic and signal amplitude characteristic regarding the 3T mark as shown in FIG. 5, in the optical disc device 1a, appropriate focus offset processing can be performed by calculating and setting a focus offset for recording or reproduction respectively for the first recording layer (L0 layer) and the second recording layer (L1 layer) using the expressions 2 and 3.

FIG. 6 is a flowchart showing the operation of the focus offset processing by the optical disc device 1a in FIG. 1 for the first recording layer (L0 layer) and the second recording layer (L1 layer) as the adjacent recording layers in the optical disc 2. As in the case of FIGS. 4 and 5, in the focus offset processing, the focus offset learning unit 321 learns an optimum focus offset using the push-pull signal.

Upon focus offset processing by the optical disc device 1a with respect to the optical disc 2 having plural recording layers, when a and c are connected in FIG. 6,

(1) First, the system controller 30 as a controller controls the optical disc device 1a to a status where the tracking control is off (OFF) and the focus control is on (ON). That is, the system controller 30 controls the focus/tracking controller 14 not to output the tracking control signal but output only the focus control signal (step S601).
(2) Then laser light is emitted from the optical system 5 to the first recording layer (L0 layer) of the mutually adjacent recording layers in the optical disc 2, and the focus offset learning unit 321 as a part of the microcomputer 32 in the system controller 30 learns (detects) the focus offset F_{A0} when the amplitude of the push-pull signal outputted from the reproduction signal processor 10 is maximum as an optimum focus offset for the first recording layer (L0 layer) (step S602). The learned optimum focus offset F_{A0} is stored in the memory 40.
(3) Then laser light is emitted from the optical system 5 to the second recording layer (L1 layer) of the mutually adjacent recording layers in the optical disc 2, and the focus offset learning unit 321 learns (detects) the focus offset F_{A1} when the amplitude of the push-pull signal outputted from the reproduction signal processor 10 is maximum as an optimum focus offset for the second recording layer (L1 layer) (step S603). The learned optimum focus offset F_{A1} is stored in the memory 40.
(4) The focus offset calculation-setting unit 322 as a part of the microcomputer 32 in the system controller 30 calculates and sets the focus offset F_{Q0} for information recording or reproduction for the first recording layer (L0 layer) based on the above-described optimum focus offsets F_{A0} and F_{A1} learned by the focus offset learning unit 321 (step S606). The focus offset calculation-setting unit 322 calculates the focus offset F_{Q0} as a focus offset weighted to the focus offset F_{A0} side in correspondence with the characteristic of the optical system 5 (i.e., the difference from the focus offset F_{A0} is smaller than the difference from the focus offset F_{A1}) using e.g. the expression 2. The set focus offset F_{Q0} is stored in the memory 40.
(5) The focus offset calculation-setting unit 322 calculates and sets the focus offset F_{Q1} for recording or reproduction in the second recording layer (L1 layer) based on the learned optimum focus offsets F_{A0} and F_{A1} (step S607). The focus offset calculation-setting unit 322 calculates the focus offset F_{Q1} as a focus offset weighted to the focus offset F_{A1} side in correspondence with the characteristic of the optical system 5 (i.e., the difference from the focus offset F_{A1} is smaller than the difference from the focus offset F_{A0}) using e.g. the expression 3. The set focus offset F_{Q1} is stored in the memory 40.
(6) The system controller 30 controls the optical disc device 1a to start the recording or reproduction operation with respect to the optical disc 2 using the above-described set focus offsets F_{Q0} and F_{Q1} (step S608). The optical disc device 1a performs recording or reproduction in the first recording layer (L0 layer) using the set focus offset F_{Q0}, and performs recording or reproduction in the second recording layer (L1 layer) using the set focus offset F_{Q1}.

Note that in the above-described focus offset learning and the focus offset calculation and setting, the processing for the first recording layer (L0) is performed prior to the processing for the second recording layer (L1), however, the processing for the second recording layer (L1 layer) may be performed first.

The above-described focus offset processing with respect to the optical disc 2 is performed by execution of the above-described series of operation procedures by the focus offset learning unit 321 and the focus offset calculation-setting unit 322 in accordance with the programs stored in the memory.

Further, upon focus offset processing with respect to the optical disc 2 having plural recording layers by the optical disc device 1a, when a and b are connected in FIG. 6,

(1) First, the system controller 30 as a controller controls the optical disc device 1a to a status where the tracking control is off (OFF) and the focus control is on (ON). That is, the system controller 30 controls the focus/tracking controller 14 not to output the tracking control signal but output only the focus control signal (step S601).
(2) Then laser light is emitted from the optical system 5 to the first recording layer (L0 layer) of the mutually adjacent recording layers in the optical disc 2, and the focus offset learning unit 321 as a part of the microcomputer 32 in the system controller 30 learns (detects) the focus offset F_{A0} when the amplitude of the push-pull signal outputted from the reproduction signal processor 10 is maximum as an optimum focus offset for the first recording layer (L0 layer) (step S602). The learned optimum focus offset F_{A0} is stored in the memory 40.
(3) Then laser light is emitted from the optical system 5 to the second recording layer (L1 layer) of the mutually adjacent recording layers in the optical disc 2, and the focus offset learning unit 321 learns (detects) the focus offset F_{A1} when the amplitude of the push-pull signal outputted from the reproduction signal processor 10 is maximum as an optimum focus offset for the second recording layer (L1 layer) (step S603). The learned optimum focus offset F_{A1} is stored in the memory 40.
(4) The focus offset calculation-setting unit 322 as a part of the microcomputer 32 in the system controller 30 calculates and sets the focus offset F_{QC} common to the first recording layer (L0 layer) and the second recording layer (L1 layer) based on the above-described optimum focus offsets F_{A0} and F_{A1} learned by the focus offset learning unit 321, as a focus offset for recording or reproduction (step S604). The focus offset calculation-setting unit 322 calculates the focus offset F_{QC} as a mean value of the both focus offsets F_{A0} and F_{A1} using e.g. the expression 1. The set focus offset F_{QC} is stored in the memory 40.
(5) The system controller 30 controls the optical disc device 1a to start the recording or reproduction operation with respect to the optical disc 2 using the above-described set the focus offset F_{QC} (step S605). The optical disc device 1a performs recording or reproduction in the first recording layer (L0 layer) using the focus offset F_{QC}, and performs recording or reproduction in the second recording layer (L1 layer) using the set focus offset F_{QC}.

Note that in the above-described focus offset learning, the learning for the first recording layer (L0 layer) is performed prior to the learning for the second recording layer (L1 layer), however, the learning for the second recording layer (L1 layer) may be performed first.

The above-described focus offset processing with respect to the optical disc 2 is performed by execution of the above-described series of operation procedures by the focus offset learning unit 321 and the focus offset calculation-setting unit 322 in accordance with the program stored in the memory 40.

FIG. 7 is a graph explaining the focus offset processing for the optical disc 2 in the optical disc device 1a when the optical disc 2 has three or more recording layers. The focus offset learning by the focus offset learning unit 321 is also performed using the push-pull signal. In FIG. 7, the horizontal axis indicates the focus offset F, and the vertical axis, the push-pull signal amplitude A.

In FIG. 7, reference numeral A₀ denotes an amplitude characteristic curve of the push-pull signal outputted from the reproduction signal processor 10 based on reflected light from the guide groove of the first recording layer (L0 layer); A₀ₘₐₓ, an amplitude value learned by the focus offset learning unit 321, i.e., a maximum value on the amplitude characteristic curve A₀ i.e. a maximum value of the push-pull signal amplitude regarding the first recording layer (L0 layer); F_{A0}, a focus offset learned by the focus offset learning unit 321, i.e., a focus offset when the push-pull signal amplitude is the maximum value A₀ₘₐₓ on the amplitude characteristic curve A₀ i.e. an optimum focus offset for the first recording layer (L0 layer) learned from the push-pull signal; A₁, an amplitude characteristic curve of the push-pull signal outputted from the reproduction signal processor 10 based on reflected light from the guide groove of the second recording layer (L1 layer); A₁ₘₐₓ, an amplitude value learned by the focus offset learning unit 321, i.e., a maximum value on the amplitude characteristic curve A₁ i.e. a maximum value of the push-pull signal amplitude regarding the second recording layer (L1 layer); F_{A1}, a focus offset learned by the focus offset learning unit 321, i.e., a focus offset when the push-pull signal amplitude is maximum on the amplitude characteristic curve A₁ i.e. an optimum focus offset for the second recording layer (L1 layer) learned from the push-pull signal; A₂, an amplitude characteristic curve of the push-pull signal outputted from the reproduction signal processor 10 based on reflected light from the guide groove of the third recording layer (L2 layer); A₂ₘₐₓ, am amplitude value learned by the focus offset learning unit 321, i.e., a maximum value on the amplitude characteristic curve A₂ i.e. a maximum value of the push-pull signal amplitude regarding the third recording layer (L2 layer); and F_{A2}, a focus offset learned by the focus offset learning unit 321, i.e., a focus offset when the push-pull signal amplitude is maximum on the amplitude characteristic curve A₂ i.e. an optimum focus offset regarding the third recording layer (L2 layer) learned from the push-pull signal.

Further, in FIG. 7, numeral Q₀ denotes the position of a focus offset calculated and set by the focus offset calculation-setting unit 322 based on the above-described focus offsets (optimum focus offsets) F_{A0} and F_{A1} using the above-described expression 2 such that the difference between the focus offset and the focus offset F_{A0} is a value corresponding to the characteristic of the optical system 5, i.e., the position of a focus offset weighted to the focus offset F_{A0} side in correspondence with the characteristic of the optical system 5 (i.e., the difference from the focus offset F_{A0} is smaller than the difference from the focus offset F_{A1}); F_{Q0}, a focus offset corresponding to the position Q₀; Q₁ₐ, the position of a focus offset calculated and set by the focus offset calculation-setting unit 322 based on the above-described focus offsets F_{A0} and F_{A1} using the above-described expression 3 such that the difference between the focus offset and the focus offset F_{A1} is a value corresponding to the characteristic of the optical system 5, i.e., the position of a focus offset weighted to the focus offset F_{A1} side in correspondence with the characteristic of the optical system 5 (i.e., the difference from the focus offset F_{A1} is smaller than the difference from the focus offset F_{A0}); F_{Q1a}, a focus offset corresponding to the position Q₁ₐ; Q_{1b}, the position of a focus offset calculated and set by the focus offset calculation-setting unit 322 based on the above-described focus offsets F_{A1} and F_{A2} using the above-described expression 2 such that the difference between the focus offset and the focus offset F_{A1} is a value corresponding to the characteristic of the optical system 5, i.e., the position of a focus offset weighted to the focus offset F_{M} side in correspondence with the characteristic of the optical system 5 (i.e., the difference from the focus offset F_{A1} is smaller than the difference from the focus offset F_{A2}); F_{Q1b}, a focus offset corresponding to the position Q_{1b}; Q₂, the position of a focus offset calculated and set by the focus offset calculation-setting unit 322 based on the above-described focus offsets F_{A1} and F_{A2} using the above-described expression 3 such that the difference between the focus offset and the focus offset F_{A2} is a value corresponding to the characteristic of the optical system 5, i.e., the position of a focus offset weighted to the focus offset F_{A2} side in correspondence with the characteristic of the optical system 5 (i.e., the difference from the focus offset F_{A2} is smaller than the difference from the focus offset F_{A1}); F_{Q2}, a focus offset corresponding to the position Q₂; Q_{1c}, the position of a mean value focus offset of the above-described focus offsets F_{Q1a} and F_{Q1b} calculated and set by the focus offset calculation-setting unit 322; and F_{Q1c}, a focus offset corresponding to the position Q_{1c}. Note that on the horizontal axis in FIG. 7, the position of the focus offset F=0 in the first recording layer (L0 layer), the position of the focus offset F=0 in the second recording layer (L1 layer), and the focus offset F=0 in the third recording layer (L2 layer) are overlapped each other.

FIG. 8 is a flowchart showing the operation of the focus offset processing in FIG. 7.

In FIG. 8,

(1) The system controller 30 as a controller controls the optical disc device 1a to a status where the tracking control is off (OFF) and the focus control is on (ON) (step S801).
(2) Then laser light is emitted from the optical system 5 to the first recording layer (L0 layer) of the mutually adjacent recording layers in the optical disc 2, and the focus offset learning unit 321 learns (detects) the focus offset F_{A0} when the amplitude of the push-pull signal outputted from the reproduction signal processor 10 is maximum as an optimum focus offset for the first recording layer (L0 layer) (step S802). The learned optimum focus offset F_{A0} is stored in the memory 40.
(3) Then laser light is emitted from the optical system 5 to the second recording layer (L1 layer) of the mutually adjacent recording layers in the optical disc 2, and the focus offset learning unit 321 learns (detects) the focus offset F_{A1} when the amplitude of the push-pull signal outputted from the reproduction signal processor 10 is maximum as an optimum focus offset for the second recording layer (L1 layer) (step S803). The learned optimum focus offset F_{A1} is stored in the memory 40.
(4) Then laser light is emitted from the optical system 5 to the third recording layer (L2 layer) in the optical disc 2, and the focus offset learning unit 321 learns (detects) the focus offset F_{A2} when the amplitude of the push-pull signal outputted from the reproduction signal processor 10 is maximum as an optimum focus offset for the third recording layer (L2 layer) (step S804). The learned optimum focus offset F_{A2} is stored in the memory 40.
(5) The focus offset calculation-setting unit 322 calculates and sets the focus offset F_{Q0} for information recording or reproduction for the first recording layer (L0 layer) based on the above-described optimum focus offsets F_{A0} and F_{A1} learned by the focus offset learning unit 321 (step S805). The focus offset calculation-setting unit 322 calculates the focus offset F_{Q0} as a focus offset weighted to the focus offset F_{A0} side in correspondence with the characteristic of the optical system 5 (i.e., the difference from the focus offset F_{A0} is smaller than the difference from the focus offset F_{A1}), using the expression 2. The set focus offset F_{Q0} is stored in the memory 40.
(6) The focus offset calculation-setting unit 322 calculates the focus offset F_{Q1a} for recording or reproduction for the second recording layer (L1 layer) based on the above-described learned optimum focus offsets F_{A0} and F_{A1} (step S806). The focus offset calculation-setting unit 322 calculates the focus offset F_{Q1a} as a focus offset weighted to the focus offset F_{A1} side in correspondence with the characteristic of the optical system 5 (i.e., the difference from the focus offset F_{A1} is smaller than the difference from the focus offset F_{A0}), using the expression 3. The calculated focus offset F_{Q1a} is stored in the memory 40.
(7) The focus offset calculation-setting unit 322 calculates the focus offset F_{Q1b} for recording or reproduction in the second recording layer (L1 layer) based on the above-described learned optimum focus offsets F_{A1} and F_{A2} (step S807). The focus offset calculation-setting unit 322 calculates the focus offset F_{Q1b} as a focus offset weighted to the focus offset F_{A1} side in correspondence with the characteristic of the optical system 5 (i.e., the difference from the focus offset F_{A1} is smaller than the difference from the focus offset F_{A2}), using the expression 2. Note that in this calculation, in the expression 2, “F_{A0}” is substituted with “F_{A1}” and “F_{A1}” is substituted with “F_{A2}”, and the calculation is performed. The calculated focus offset F_{Q1b} is stored in the memory 40.
(8) The focus offset calculation-setting unit 322 calculates the focus offset F_{Q2} for recording or reproduction for the third recording layer (L2 layer) based on the above-described learned optimum focus offsets F_{A1} and F_{A2} (step S808). The focus offset calculation-setting unit 322 calculates the focus offset F_{Q2} as a focus offset weighted to the focus offset F_{A2} side in correspondence with the characteristic of the optical system 5 (i.e., the difference from the focus offset F_{A2} is smaller than the difference from the focus offset F_{A1}), using the expression 3. Note that in this calculation, in the expression 3, “F_{A0}” is substituted with “F_{A1}” and “F_{A1}” is substituted with “F_{A2}”, and the calculation is performed. The set focus offset F_{Q2} is stored in the memory 40.
(9) The focus offset calculation-setting unit 322 calculates and sets the focus offset F_{Q1c} for recording or reproduction for the second recording layer (L1 layer) based on the above-described focus offsets F_{Q1a} and F_{Q1b} as a mean value of the focus offsets F_{Q1a} and F_{Q1b} (step S809). The set focus offset F_{Q1c} is stored in the memory 40.
(10) The system controller 30 controls the optical disc device 1a to start information recording or reproduction with respect to the optical disc 2 using the above-described set focus offsets F_{Q0}, F_{Q1c} and F_{Q2} (step S810). The optical disc device 1a performs information recording or reproduction for the first recording layer (L0 layer) using the set focus offset F_{Q0}, performs information recording or reproduction with respect to the second recording layer (L1 layer) using the set focus offset F_{Q1c}, and performs information recording or reproduction with respect to the third recording layer (L2 layer) using the set focus offset F_{Q2}.

Note that in the above-described focus offset learning, calculation and setting in FIGS. 7 and 8, the focus offset calculation-setting unit 322 calculates and sets the focus offset F_{Q1c} as a mean value of the focus offsets F_{Q1a} and F_{Q1b} for the second recording layer (L1 layer), however, it may be arranged such that a focus offset when the difference between the focus offset and these focus offsets F_{Q1a} and F_{Q1b} is a value corresponding to the characteristic of the optical system 5 is calculated and set. Further, in the above-described focus offset learning, calculation and setting in FIGS. 7 and 8, the order of processing is the processing for the first recording layer (L0 layer), the processing for the second recording layer (L1 layer) and the processing for the third recording layer (L2 layer), however, the order of processing is not limited to this order.

In the above-described focus offset processing for the optical disc 2, the focus offset leaning unit 321 and the focus offset calculation-setting unit 322 respectively perform the series of operation procedures at the above-described steps S801 to S809 in accordance with the programs stored in the memory 40.

FIG. 9 is a graph explaining focus offset processing different from that in the case of FIGS. 7 and 7 by the optical disc device 1a with respect to the optical disc 2 when the optical disc 2 has three or more recording layers. The focus offset learning by the focus offset leaning unit 321 is also performed using the push-pull signal. In FIG. 9, the horizontal axis indicates the focus offset F, and the vertical axis, the push-pull signal amplitude A.

In FIG. 9, reference numeral A₀ denotes an amplitude characteristic curve of the push-pull signal outputted from the reproduction signal processor 10 based on reflected light from the guide groove of the first recording layer (L0 layer); A₀ₘₐₓ, an amplitude value learned by the focus offset learning unit 321, i.e., a maximum value on the amplitude characteristic curve A₀ i.e. a maximum value of the push-pull signal amplitude regarding the first recording layer (L0 layer); F_{A0}, a focus offset learned by the focus offset learning unit 321, i.e., a focus offset when the push-pull signal amplitude is the maximum value A₀ₘₐₓ on the amplitude characteristic curve A₀ i.e. an optimum focus offset for the first recording layer (L0 layer) learned from the push-pull signal; A₁, an amplitude characteristic curve of the push-pull signal outputted from the reproduction signal processor 10 based on reflected light from the guide groove of the second recording layer (L1 layer); A₁ₘₐₓ, an amplitude value learned by the focus offset learning unit 321, i.e., a maximum value on the amplitude characteristic curve A₁ i.e. a maximum value of the push-pull signal amplitude regarding the second recording layer (L1 layer); F_{A1}, a focus offset learned by the focus offset learning unit 321, i.e., a focus offset when the push-pull signal amplitude is maximum on the amplitude characteristic curve A₁ i.e. an optimum focus offset for the second recording layer (L1 layer) learned from the push-pull signal; A₂, an amplitude characteristic curve of the push-pull signal outputted from the reproduction signal processor 10 based on reflected light from the guide groove of the third recording layer (L2 layer); A₂ₘₐₓ, an amplitude value learned by the focus offset learning unit 321, i.e., a maximum value on the amplitude characteristic curve A₂ i.e. a maximum value of the push-pull signal amplitude regarding the third recording layer (L2 layer); and F_{A2}, a focus offset learned by the focus offset learning unit 321, i.e., a focus offset when the push-pull signal amplitude is maximum on the amplitude characteristic curve A₂ i.e. an optimum focus offset regarding the third recording layer (L2 layer) learned from the push-pull signal.

Further, in FIG. 9, numeral Q₀ denotes the position of a focus offset calculated and set by the focus offset calculation-setting unit 322 based on the above-described focus offsets (optimum focus offsets) F_{A0} and F_{A1} using the above-described expression 2 such that the difference between the focus offset and the focus offset F_{A0} is a value corresponding to the characteristic of the optical system 5, i.e., the position of a focus offset weighted to the focus offset F_{A0} side in correspondence with the characteristic of the optical system 5 (i.e., the difference from the focus offset F_{A0} is smaller than the difference from the focus offset F_{A1}); F_{Q0}, a focus offset corresponding to the position Q₀; Q₁ₐ, the position of a focus offset calculated and set by the focus offset calculation-setting unit 322 based on the above-described focus offsets F_{A0} and F_{A1}, using the above-described expression 3 such that the difference between the focus offset and the focus offset F_{A1} is a value corresponding to the characteristic of the optical system 5, i.e., the position of a focus offset weighted to the focus offset F_{A1} side in correspondence with the characteristic of the optical system 5 (i.e., the difference from the focus offset F_{A1} is smaller than the difference from the focus offset F_{A0}); F_{Q1a}, a focus offset corresponding to the position Q₁ₐ; Q_{1b}, the position of a focus offset calculated and set by the focus offset calculation-setting unit 322 based on the above-described focus offsets F_{A1} and F_{A2} using the above-described expression 2 such that the difference between the focus offset and the focus offset F_{A1} is a value corresponding to the characteristic of the optical system 5, i.e., the position of a focus offset weighted to the focus offset F_{A1} side in correspondence with the characteristic of the optical system 5 (i.e., the difference from the focus offset F_{A1} is smaller than the difference from the focus offset F_{A2}); F_{Q1b}, a focus offset corresponding to the position Q_{1b}; Q₂, the position of a focus offset calculated and set by the focus offset calculation-setting unit 322 based on the above-described focus offsets F_{A1} and F_{A2} using the above-described expression 3 such that the difference between the focus offset and the focus offset F_{A2} is a value corresponding to the characteristic of the optical system 5, i.e., the position of a focus offset weighted to the focus offset F_{A2} side in correspondence with the characteristic of the optical system 5 (i.e., the difference from the focus offset F_{A2} is smaller than the difference from the focus offset F_{A1}); F_{Q2}, a focus offset corresponding to the position Q₂. Note that as in the case of FIG. 7, on the horizontal axis in FIG. 9, the position of the focus offset F=0 in the first recording layer (L0 layer), the position of the focus offset F=0 in the second recording layer (L1 layer), and the focus offset F=0 in the third recording layer (L2 layer) are overlapped each other.

FIG. 10 is a flowchart showing the operation of the focus offset processing in FIG. 9.

In FIG. 10,

(1) The system controller 30 as a controller controls the optical disc device 1a to a status where the tracking control is off (OFF) and the focus control is on (ON) (step S1001).
(2) Then laser light is emitted from the optical system 5 to the first recording layer (L0 layer) of the mutually adjacent recording layers in the optical disc 2, and the focus offset learning unit 321 learns (detects) the focus offset F_{A0} when the amplitude of the push-pull signal outputted from the reproduction signal processor 10 is maximum as an optimum focus offset for the first recording layer (L0 layer) (step S1002). The learned optimum focus offset F_{A0} is stored in the memory 40.
(3) Then laser light is emitted from the optical system 5 to the second recording layer (L1 layer) of the mutually adjacent recording layers in the optical disc 2, and the focus offset learning unit 321 learns (detects) the focus offset F_{A1} when the amplitude of the push-pull signal outputted from the reproduction signal processor 10 is maximum as an optimum focus offset for the second recording layer (L1 layer) (step S1003). The learned optimum focus offset F_{A1} is stored in the memory 40.
(4) Then laser light is emitted from the optical system 5 to the third recording layer (L2 layer) in the optical disc 2, and the focus offset learning unit 321 learns (detects) the focus offset F_{A2} when the amplitude of the push-pull signal outputted from the reproduction signal processor 10 is maximum as an optimum focus offset for the third recording layer (L2 layer) (step S1004). The learned optimum focus offset F_{A2} is stored in the memory 40.
(5) The focus offset calculation-setting unit 322 calculates and sets the focus offset F_{Q0} for information recording or reproduction for the first recording layer (L0 layer) based on the above-described optimum focus offsets F_{A0} and F_{A1} learned by the focus offset learning unit 321 (step S1005). The focus offset calculation-setting unit 322 calculates the focus offset F_{Q0} as a focus offset weighted to the focus offset F_{A0} side in correspondence with the characteristic of the optical system 5 (i.e., the difference from the focus offset F_{A0} is smaller than the difference from the focus offset F_{A1}), using e.g. the expression 2. The set focus offset F_{Q0} is stored in the memory 40.
(6) The focus offset calculation-setting unit 322 calculates the focus offset F_{Q1a} based on the above-described learned optimum focus offsets F_{A0} and F_{A1} using e.g. the expression 3 as a focus offset weighted to the focus offset F_{A1} side in correspondence with the characteristic of the optical system 5 (i.e., the difference from the focus offset F_{A1} is smaller than the difference from the focus offset F_{A0}), and calculates and sets the focus offset F_{Q1b} for recording or reproduction for the second recording layer (L1 layer) based on the above-described learned optimum focus offsets F_{A1} and F_{A2} (step S1006). The focus offset calculation-setting unit 322 calculates the focus offset F_{Q1b} as a focus offset weighted to the focus offset F_{A1} side in correspondence with the characteristic of the optical system 5 (i.e., the difference from the focus offset F_{A1} is smaller than the difference from the focus offset F_{A2}), using e.g. the expression 2. Note that in this calculation, in the expression 2, “F_{A0}” is substituted with “F_{A1}” and “F_{A1}” is substituted with “F_{A2}”, and the calculation is performed. The calculated focus offset F_{Q1b} is stored in the memory 40. Note that as the above-described calculated focus offset F_{Q1a} is positioned on the laser-light incident side (the side on which the objective lens 5a is provided) from the focus offset F_{Q1b}, it is not employed as a focus offset for recording or reproduction for the second recording layer (L1 layer). Accordingly, the focus offset F_{Q1a} is not stored in the memory 40.
(7) The focus offset calculation-setting unit 322 calculates the focus offset F_{Q2} for recording or reproduction for the third recording layer (L2 layer) based on the above-described optimum focus offsets F_{A1} and F_{A2} (step S1007). The focus offset calculation-setting unit 322 calculates the focus offset F_{Q2} as a focus offset weighted to the focus offset F_{A2} side in correspondence with the characteristic of the optical system 5 (i.e., the difference from the focus offset F_{A2} is smaller than the difference from the focus offset F_{A1}), using e.g. the expression 3. Note that in this calculation, in the expression 3, “F_{A0}” is substituted with “F_{A1}” and “F_{A1}” is substituted with “F_{A2}”, and the calculation is performed. The set focus offset F_{Q2} is stored in the memory 40.
(8) The system controller 30 controls the optical disc device 1a to start recording or reproduction with respect to the optical disc 2 using the set focus offsets F_{Q0}, F_{Q1b} and F_{Q2} (step S1008). The optical disc device 1a performs recording or reproduction for the first recording layer (L0 layer) using the set focus offset F_{Q0}, performs recording or reproduction for the second recording layer (L1 layer) using the set focus offset F_{Q1b}, and performs recording or reproduction for the third recording layer (L2 layer) using the set focus offset F_{Q2}.

Note that in the above-described focus offset learning, calculation and setting in FIGS. 9 and 10, the order of processing is the processing for the first recording layer (L0 layer), the processing for the second recording layer (L1 layer) and the processing for the third recording layer (L2 layer), however, the order of processing is not limited to this order.

In the above-described focus offset processing for the optical disc 2, the focus offset leaning unit 321 and the focus offset calculation-setting unit 322 respective perform the series of operation procedures at the above-described steps S1001 to S1007 in accordance with the programs stored in the memory 40.

According to the optical disc device 1a in the first embodiment of the present invention, as a focus offset for recording or reproduction in mutually adjacent recording layers can be calculated and set directly from the result of learning of maximum amplitude of a push-pull signal or wobble signal, the time for focus offset processing for plural recording layers in the optical disc 2 can be shortened, and a recording or reproduction operation can be started in short time. Further, as focus offset learning is performed utilizing groove information on a guide groove in a recording surface such as the push-pull signal or wobble signal, the focus offset learning can be performed in a recording layer in recorded status (including a reproduction-only disc) and a recording layer in unrecorded status. Further, the accuracy of the focus offset processing can be improved.

Note that in the above-described embodiment, when the focus offset calculation-setting unit 322 calculates and sets a common focus offset to the first recording layer (L0 layer) and the second recording layer (L1 layer) mutually adjacent in the optical disc 2 as a focus offset for recording or reproduction, the focus offset calculation-setting unit 322 calculates and sets a mean value (F_{A0}+F_{A1})/2 of the focus offsets F_{A0} and F_{A1} learned by the focus offset leaning unit 321 using the expression 1. However, it may be arranged such that a focus offset other than the mean value i.e. a common focus offset when the difference between the focus offset and the optimum focus offsets F_{A0} and F_{A1} for the respective recording layers is different is calculated and set by (m×F_{A0}+n×F_{A1})/(m+n) in correspondence with e.g. the characteristic of the optical system 5. Note that m, n are coefficients determined in correspondence with the characteristic of the optical system 5. Further, in the embodiment shown in FIG. 7, the focus offset F_{Q1c} for recording or reproduction in the second recording layer (L1 layer) is calculated and set as a mean value of the focus offsets F_{Q1a} and F_{Q1b} (step S809). However, it may be arranged such that the focus offset F_{Q1c} is calculated and set as a common focus offset when the difference between the focus offset and the focus offsets F_{Q1a} and F_{Q1b} is different in correspondence with e.g. the characteristic of the optical system 5.

Further, in the above-described embodiment, when the optical disc 2 has three or more recording layers, the optical disc device 1a performs the focus offset processing for at least the first, the second and the third recording layers of the optical disc 2. The optical disc device 1a further performs focus offset processing basically the same as the above focus offset processing for other recording layers in the optical disc 2. That is, regarding mutually adjacent recording layers, a focus offset for an optical system with respect to the guide grooves of the respective recording layers is learned from a signal based on reflected light from a guide groove formed in a recording surface of the recording layer, and based on the result of learning, a focus offset for recording or reproduction is calculated and set.

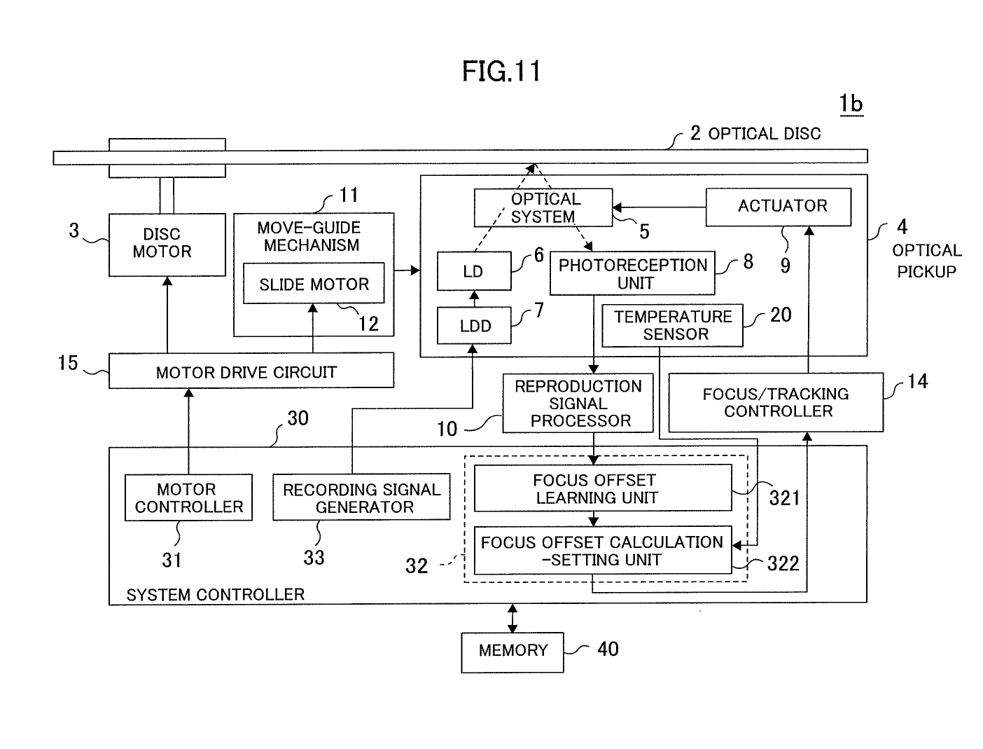

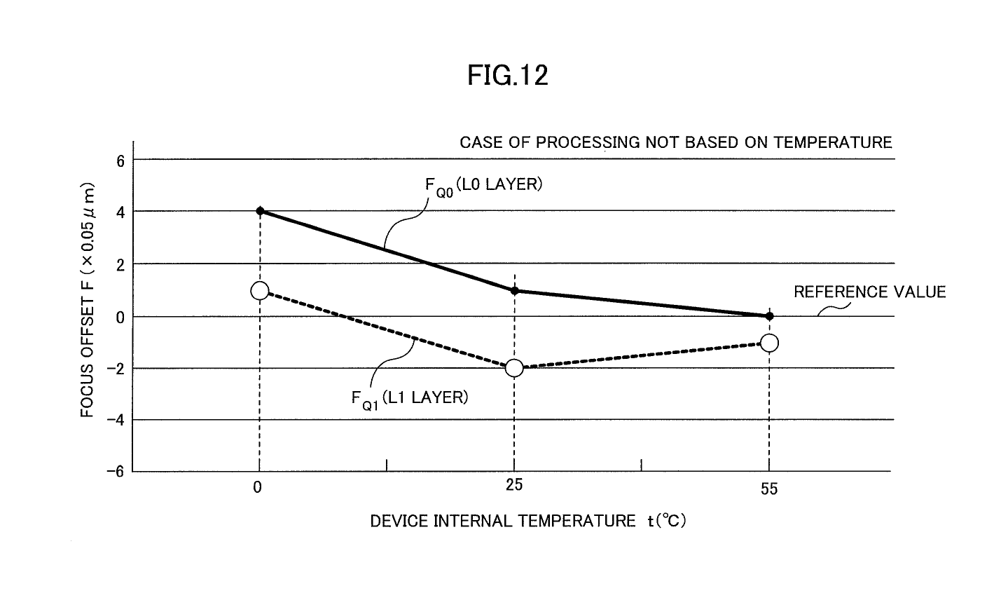

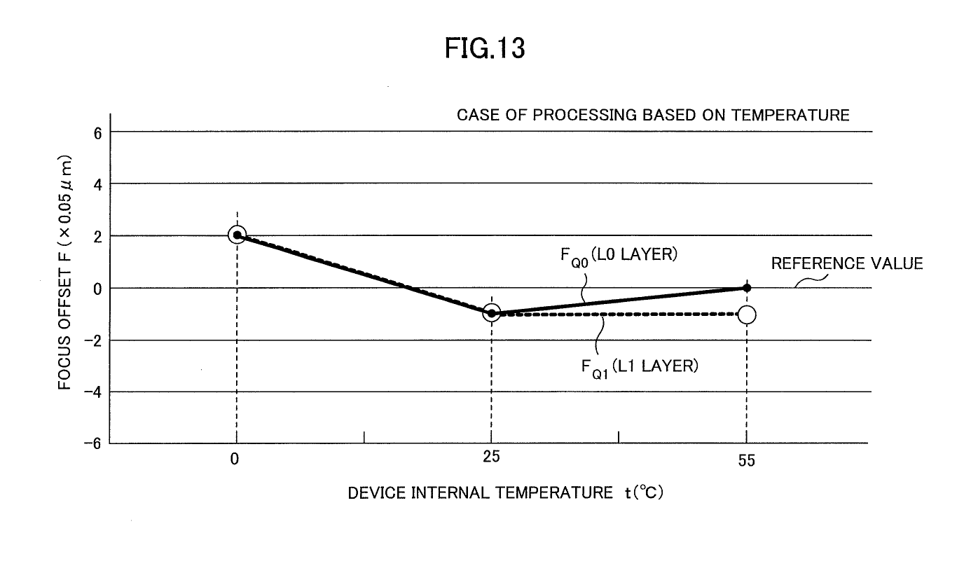

FIGS. 11 to 13 are used for explaining the optical disc device in a second embodiment of the present invention. The second embodiment shows a case where a focus offset for the optical system for recording or reproduction is calculated and set in correspondence with temperature change in the device. FIG. 11 is a block diagram of the optical disc device in the second embodiment of the present invention; FIG. 12 is a graph showing an example of the temperature characteristic of focus offset for the optical system in the optical disc device; and FIG. 13 is a graph showing a status when the temperature characteristic in FIG. 12 is improved by using the optical disc device in FIG. 11.

Note that as in the case of the above-described first embodiment, the “recording layer” used in the following description means a layer in which information is recorded (recording layer), and includes a recording layer in which information is already recorded (including a recording layer of a reproduction-only disc and a recording layer of a recordable disc) and a recording layer in which information is not recorded yet but will be recorded (in this case, a recording layer of a recordable disc).

In FIG. 11, reference numeral 1b denotes an optical disc device in the embodiment of the present invention; 2, an optical disc such as a DVD+/−R DL having plural recording layers; 3, a disc motor to rotate-drive the optical disc 2; 4, an optical pickup; 5, an optical system including an objective lens (not shown), provided in the optical pickup 4, to collect laser light and emit the collected laser light on a recording surface of the optical disc 2; 6, a laser diode provided in the optical pickup 4, to generate laser light in predetermined intensity for recording or reproduction; 7, a laser drive circuit provided in the optical pickup 4, to drive the laser diode 6; 8, a photoreception unit provided in the optical pickup 4, to receive reflected light from the recording surface (disc surface) of the optical disc 2 via the optical system 5, convert the received light into an electric signal (reproduction signal) and output the signal; 9, an actuator to change the position and attitude of the objective lens (not shown) in the optical system 5; 20, a temperature sensor as a temperature detection unit to detect a temperature in the optical disc device 1b; 10, a reproduction signal processor to perform signal processing on the reproduction signal outputted from the photoreception unit 8, as an RF signal, by performing amplification, demodulation and the like; 11, a move-guide mechanism having a linear guide member (not shown), a lead screw member (not shown) and the like to move the optical pickup 4 in an approximately radial direction of the optical disc 2; 12, a slide motor provided in the move-guide mechanism 11, to rotate-drive the lead screw member (not shown); 14, a focus/tracking controller to generate a drive signal to drive the actuator 9; 15, a motor drive circuit to rotate-drive the disc motor 3 and the slide motor 12; 30, a system controller as a controller to control the entire optical disc device 1a; 31, a motor controller provided in the system controller 30, to control the motor drive circuit 15; 32, a microcomputer in the system controller 30; 321, a focus offset learning unit as a first controller provided in the microcomputer 32, to learn (detect) an optimum focus offset (a focus offset within an optimum range i.e. a focus offset within an appropriate range in the present invention. In the following description, all the “optimum focus offset” mean this focus offset) for the optical system 5 from a signal outputted from the reproduction signal processor 10; and 322, a focus offset calculation-setting unit as a second controller provided in the microcomputer 32, to calculate and set a focus offset for the optical system 5 for recording or reproduction based on the optimum focus offset learned by the above-described focus offset learning unit 321 and temperature information detected by the above-described temperature sensor 20. Upon learning of the optimum focus offset, the focus offset learning unit 321 as the first controller learns (detects) the optimum focus offset for the optical system 5 with respect to respective guide grooves based on the signal outputted from the reproduction signal processor 10, i.e., a signal based on reflected light from a guide groove formed in respective recording surfaces of mutually adjacent recording layers among plural recording layers of the optical disc 2. The temperature sensor 20, provided around the laser diode 6 in the optical pickup 4, detects an ambient temperature of the laser diode 6 as a temperature in the optical disc device 1b.

Further, in FIG. 11, numeral 33 denotes a recording signal generator to generate and output a recording signal to drive the laser diode 6; and 40, a memory holding characteristic information of the optical system 5, information on the optimum focus offsets for respective adjacent recording layers learned by the focus offset learning unit 321, information on the focus offset for the optical system 5 for recording or reproduction calculated and set by the focus offset calculation-setting unit 322, a program to cause the focus offset learning unit 321 to execute the series of procedures of learning operation, a program to cause the focus offset calculation-setting unit 322 to execute the series of procedures of calculation-setting operation, and the like. The characteristic information of the optical system 5, the program for execution of the learning operation, and the program for execution of the calculation and setting operation are previously stored in the memory 40 prior to the optimum focus offset learning operation by the focus offset learning unit 321.

In focus offset processing, upon the above-described focus offset learning, as a signal based on the reflected light from the guide groove formed in the recording surfaces of mutually adjacent plural recording layers, a push-pull signal or a wobble signal is outputted from the reproduction signal processor 10.

Upon optimum focus offset learning, the focus offset learning unit 321 as the first controller uses the push-pull signal or the wobble signal outputted from the reproduction signal processor 10, and learns (detects) focus offsets when the amplitude of the push-pull signal or the wobble signal is maximum (a value within a substantially maximum range, i.e., a value within a range including a true maximum value and e.g. 95% of the true maximum value. Hereinbelow, “maximum” or “maximum value” in the amplitude of the push-pull signal or the wobble signal has this meaning) as respective optimum focus offsets with respect to the respective guide grooves of the mutually adjacent plural recording layers. When the optimum focus offset is learned from the push-pull signal, tracking control is turned off (OFF). When the optimum focus offset is learned from the wobble signal, the tracking control is turned on (ON). The focus offset learning unit 321 performs predetermined procedures in the optimum focus offset learning operation in accordance with the program read from the memory 40.

When the focus offset calculation-setting unit 322 as the second controller calculates and sets a focus offset for information recording or reproduction with respect to mutually adjacent plural recording layers, the focus offset calculation-setting unit 322 calculates a mean value (mean focus offset) of respective optimum focus offsets for the plural recording layers i.e. focus offsets when the amplitude of the above-described push-pull signal or the wobble signal is maximum, in correspondence with the temperature detected by the above-described temperature sensor 20, and sets the calculated mean value as a common focus offset to the both recording layers upon recording or reproduction. Otherwise, the focus offset calculation-setting unit 322 calculates a focus offset when the difference between the focus offset and the optimum focus offsets for the respective recording layers learned by the focus offset learning unit 321 is a value corresponding to the characteristic of the optical system 5 i.e. a focus offset weighted by recording layer in correspondence with the characteristic of the optical system 5, and individually sets the calculated focus offset by recording layer as a focus offset for recording or reproduction in the above-described mutually adjacent plural recording layers.

When the above-described mean focus offset for recording or reproduction is calculated and set using the result of learning by the focus offset learning unit 321, the focus offset calculation-setting unit 322 sets the focus offset as follows. That is, for example, when a first recording layer (L0 layer) and a second recording layer (L1 layer) are arranged from the laser light incident side (the side on which the optical system 5 is provided), the temperature detected by the above-described temperature sensor 20 is relatively low (i.e. a first temperature), e.g., the temperature (the first temperature) is within a range from 0° C. to 25° C., when F_{A0} is obtained as a focus offset when the amplitude of the push-pull signal or the wobble signal is maximum by learning by the focus offset learning unit 321 with respect to the first recording layer (L0 layer) and F_{A1} is obtained as a focus offset when the amplitude of the push-pull signal or the wobble signal is maximum by learning with respect to the second recording layer (L1 layer), a value obtained by calculating a focus offset F_{Q0} for recording or reproduction for the first recording layer (L0 layer) and a focus offset F_{Q1} for recording or reproduction for the second recording layer (L1 layer), by

F_{Q0}=F_{Q1}=(F_{A0}+F_{A1})/2 (Expression 4)

is set as a common focus offset (focus offset for recording or reproduction) F_{Qc} (FIG. 3) to the first recording layer (L0 layer) and the second recording layer (L1 layer).

Further, when the temperature detected by the above-described temperature sensor 20 is relatively high (i.e., a second temperature) e.g., the temperature (the second temperature) is within a range from 50° C. to 65° C., the focus offset calculation-setting unit 322 individually calculates and sets a focus offset for recording or reproduction by each of adjacent recording layers in correspondence with the characteristic of the optical system 5 using the result of learning by the focus offset learning unit 321. That is, for example, when the first recording layer (L0 layer) and the second recording layer (L1 layer) are arranged from the laser light incident side, F_{A0} is obtained as a focus offset when the amplitude of the push-pull signal or the wobble signal is maximum by learning by the focus offset learning unit 321 with respect to the first recording layer (L0 layer) and F_{A1} is obtained as a focus offset when the amplitude of the push-pull signal or the wobble signal is maximum by learning with respect to the second recording layer (L1 layer), a value calculated by

F_{Q0}=(3×F_{A0}+F_{A1})/4 (Expression 2)

is set as a focus offset F_{Q0} for recording or reproduction for the first recording layer (L0 layer).

Further, as a focus offset F_{Q1} for recording or reproduction for the second recording layer (L1 layer), a value calculated by

F_{Q1}=(F_{A0}+3×F_{A1})/4 (Expression 3)

is set.

The focus offset calculation-setting unit 322 performs the operation procedures to calculate and set the above-described focus offset for the above-described optical system 5 for recording or reproduction in accordance with the program read from the memory 40.

In the optical disc device 1b having the above-described configuration, upon information recording or reproduction with respect to the optical disc 2 having plural recording layers, e.g. in a status where the optical disc 2 is loaded in the device and rotated at a predetermined speed, laser light generated by the laser diode 6 in the optical pickup 4 is emitted on recording surfaces of the plural recording layers of the optical disc 2 through the optical system 5, and focus offset processing for the plural recording layers is performed. The focus offset processing is performed by utilizing groove information on a guide groove (information indicating structure and status of the groove) formed in the respective recording layers, for mutually adjacent recording layers. That is, regarding the mutually adjacent recording layers, reflected light from the guide groove formed in the recording surface of the recording layer is received by the photoreception unit 8 then converted to an electric signal (reproduction signal), and outputted from the reproduction signal processor 10 as a push-pull signal or a wobble signal. When it is arranged such that a push-pull signal is outputted from the reproduction signal processor 10 upon focus offset processing, the tracking control is not performed in the optical disc device 1b, and only a focus control signal is outputted from the focus/tracking controller 14. On the other hand, when it is arranged such that a wobble signal is outputted from the reproduction signal processor 10, the tracking control is also performed, and focus control signal and tracking control signal are outputted from the focus/tracking controller 14. The push-pull signal or the wobble signal outputted from the reproduction signal processor 10 as groove information on the guide groove of the mutually adjacent respective recording layers is inputted into the focus offset learning unit 321 in the microcomputer 32. The focus offset learning unit 321 learns (detects) a focus offset when the amplitude of the inputted push-pull signal or wobble signal is maximum as an optimum focus offset, for the mutually adjacent respective recording layers. The focus offset calculation-setting unit 322 in the microcomputer 32 calculates a mean value of the optimum focus offsets for the mutually adjacent recording layers learned by the focus offset learning unit 321 or a focus offset when the difference between the focus offset and the learned respective optimum focus offsets is a value corresponding to the characteristic of the optical system 5, in correspondence with the temperature information from the temperature sensor 20, as described above, and sets the calculated focus offset as a focus offset for the above-described optical system for recording or reproduction.

In the above-described second embodiment, when the temperature detected by the above-described temperature sensor 20 is relatively high (i.e., the second temperature), the focus offset calculation-setting unit 322 calculates and sets the focus offset F_{Q0} for recording or reproduction for the first recording layer (L0 layer) in the optical disc 2, using the expression 2, as a focus offset weighted to the focus offset F_{A0} side (i.e., the difference from the focus offset F_{A0} is smaller than the difference from the focus offset F_{A1}), and calculates and sets the focus offset F_{Q1} for recording or reproduction for the second recording layer (L1 layer), using the expression 3, as a focus offset weighted to the focus offset F_{A1} side (i.e., the difference from the focus offset F_{A1} is smaller than the difference from the focus offset F_{A0}). Further, it may be arranged such that the focus offset calculation-setting unit 322 calculates and sets a common focus offset when the difference between the focus offset and the optimum focus offsets F_{A0} and F_{A1} for the respective recording layers is different by (m×F_{A0}+n×F_{A1})/(m+n) in correspondence with e.g. the characteristic of the optical system 5. Note that m and n are coefficients respectively determined in correspondence with the characteristic of the optical system.

Hereinbelow, the constituent elements of the optical disc device 1b used in FIG. 12 in the description have the same reference numerals as those in FIG. 11.

FIG. 12 is a graph showing the result of experiment of the temperature characteristic of focus offset for the optical system 5 in the optical disc device 1b when the focus offset calculation-setting unit 322 does not perform a processing operation based on temperature information from the temperature sensor 20 (not based on temperature).

In FIG. 12, the horizontal axis indicates a device internal temperature t (° C.) of the optical disc device 1b measured in the position of the sensor 20, and the vertical axis, the focus offset F (×0.05 μm) for the optical system 5 for recording or reproduction. In FIG. 12, numeral F_{Q0} denotes a focus offset for recording or reproduction for the first recording layer (L0 layer) in the optical disc 2 not based on temperature; F_{Q1}, a focus offset for recording or reproduction in the second recording layer (L1 layer) in the optical disc 2 not based on temperature. The focus offset F_{Q0} is calculated and set by the focus offset calculation-setting unit 322 using the expression 2 based on an optimum focus offset learned by the focus offset learning unit 321 at a normal temperature (25° C.), and the focus offset F_{Q1} is calculated and set by the focus offset calculation-setting unit 322 using the expression 3 based on an optimum focus offset learned by the focus offset learning unit 321 at the normal temperature (25° C.). As a result, when the device internal temperature t is lowered from the normal temperature (25° C.) to 0° C., as the focus offset F, the focus offsets F_{Q0} and F_{Q1} are both increased, and especially in the case of the focus offset F_{Q0}, a shift amount from a reference value (F=0) is large and is about 4×0.05 μm. Further, when the device internal temperature t is raised from the normal temperature (25° C.) to 55° C., as the focus offset F, the focus offset F_{Q0} is reduced while the focus offset F_{Q1} is increased, thereby the focus offsets F_{Q0} and F_{Q1} are both closer to the reference value (F=0) and the difference between the focus offsets F_{Q0} and F_{Q1} is reduced.

FIG. 13 shows the result of experiment of the temperature characteristic of focus offset for the optical system 5 in the optical disc device 1b when the focus offset calculation-setting unit 322 performs a processing operation based on the temperature information from the temperature sensor 20 (based on temperature).

In FIG. 13, the horizontal axis and the vertical axes are the same as those in FIG. 12. In FIG. 13, numeral F_{Q0} denotes a focus offset for recording or reproduction for the first recording layer (L0 layer) in the optical disc 2 based on temperature; F_{Q1}, a focus offset for recording or reproduction for the second recording layer (L1 layer) in the optical disc 2 based on temperature. As a processing operation of the focus offset calculation-setting unit 322 based on the temperature information from the temperature sensor 20, when the device internal temperature t is relatively low (i.e., the first temperature) including a normal temperature, e.g., 0° C. to 25° C., the focus offset calculation-setting unit 322 calculates the focus offset F_{Q0} for recording or reproduction for the first recording layer (L0 layer) in the optical disc 2 and the focus offset F_{Q1} for recording or reproduction for the second recording layer (L1 layer) using the expression 4, and sets a calculated value as a common focus offset (focus offset for recording or reproduction) F_{Qc} (FIG. 3) to the first recording layer (L0 layer) and the second recording layer (L1 layer). Further, when the device internal temperature t is relatively high (i.e., the second temperature), e.g., 55° C., the focus offset calculation-setting unit 322 calculates and sets the focus offset F_{Q0} for recording or reproduction for the first recording layer (L0 layer) in the optical disc 2 as a focus offset weighted to the focus offset F_{A0} side using the expression 2, and calculates and sets the focus offset F_{Q1} for recording or reproduction for the second recording layer (L1 layer) in the optical disc 2 as a focus offset weighted to the focus offset F_{A1} side using the expression 3. As a result, even when the device internal temperature t is lowered from the normal temperature (25° C.) to 0° C., as the focus offset F, the focus offsets F_{Q0} and F_{Q1} are both increased, however, a shift amount from the reference value (F=0) is small and is about 2×0.05 μm. Further, when the device internal temperature t is raised from the normal temperature (25° C.) to 55° C., as the focus offset F, the focus offset F_{Q0} is increased while the focus offset F_{Q1} is not changed in comparison with those at the normal temperature (25° C.). In both the focus offsets F_{Q0} and F_{Q1}, the shift amount from the reference value (F=0) is small and is about 0 to 1×0.05 μm. Accordingly, even when the device internal temperature t is changed to the low temperature side or to the high temperature side, in both the focus offsets F_{Q0} and F_{Q1}, the shift amount from the reference value (F=0) can be suppressed within about 2×0.05 μm, thus influence of the device internal temperature t on the focus offset F can be suppressed. Note that as factors of the temperature characteristic of focus offset for the optical system 5, a temperature characteristic of the optical system 5 itself, a temperature characteristic of a support member of the optical system 5, a temperature characteristic of the optical disc 2, a temperature characteristic of a support member of the optical disc 2, and the like can be considered, however, the factors are not determined.

Note that in the above description, the range of the above-described first temperature is 0° C. to 25° C., and the range of the above-described second temperature is 50° C. to 65° C., however, in the above-described optical disc device 1b, the range of the first temperature and the range of the second temperature are previously set in correspondence with the temperature characteristic of focus offset in the optical system 5.

According to the optical disc device 1b in the second embodiment of the present invention, as a focus offset for recording or reproduction in mutually adjacent recording layers can be calculated and set directly from the result of learning of maximum amplitude of a push-pull signal or wobble signal, the time for focus offset processing for plural recording layers in the optical disc 2 can be shortened, and a recording or reproduction operation can be started in short time. Further, the influence of the device internal temperature on the focus offset can be suppressed. Further, as focus offset learning is performed utilizing groove information on a guide groove in a recording surface such as the push-pull signal or wobble signal, the focus offset learning can be performed in a recording layer in recorded status (including a reproduction-only disc) and a recording layer in unrecorded status. Further, the accuracy of the focus offset processing can be improved.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. An optical disc apparatus capable of information recording or reproduction with respect to an optical disc having three or more recording layers, comprising:
an optical system which collects laser light and emits the laser light on the recording layer; and
a controller which, regarding each of a first recording layer, a second recording layer and a third recording layer, arranged from the optical system side as mutually adjacent recording layers in the optical disc, learns a focus offset for the optical system with respect to a guide groove formed in a recording surface of each of the recording layers from a signal based on reflected light from the guide groove, then, as a focus offset for recording or reproduction for the first recording layer, calculates a focus offset when a difference between the focus offset and the learned focus offset for the first recording layer is a value corresponding to a characteristic of the optical system, from the learned focus offsets for the first and second recording layers, then, as a focus offset for recording or reproduction for the third recording layer, calculates a focus offset when a difference between the focus offset and the learned focus offset for the third recording layer is a value corresponding to the characteristic of the optical system, from the learned focus offsets for the second and third recording layers, then, as a focus offset for recording or reproduction for the second recording layer, calculates a mean value of the learned focus offsets for the first, second and third recording layers, or calculates a focus offset when a difference between the focus offset and the learned focus offset for the second recording layer is a value corresponding to the characteristic of the optical system, from the learned focus offsets for the second and third recording layers, and sets respective calculation results.

2. An optical disc apparatus capable of information recording or reproduction with respect to an optical disc having a plurality of recording layers, comprising:
an optical system which collects laser light and emits the laser light on the recording layer;
a first control module which, regarding each of mutually adjacent recording layers in the optical disc, learns a focus offset for the optical system with respect to a guide groove formed in a recording surface of each of the recording layers from a signal based on reflected light from the guide groove; and
a second control module which calculates and sets a focus offset for the optical system for recording or reproduction based on the focus offsets for the respective recording layers learned by the first control module,
wherein, when the first recording layer, the second recording layer and the third recording layer are arranged from the optical system side as the plurality of recording layers,
the second control module
calculates a first focus offset when a difference between the focus offset and the learned focus offset for the first recording layer is a value corresponding to a characteristic of the optical system, and a second focus offset when a difference between the focus offset and the learned focus offset for the second recording layer is a value corresponding to the characteristic of the optical system, from the learned focus offset for the first recording layer and the learned focus offset for the second recording layer,
calculates a third focus offset when a difference between the focus offset and the learned focus offset for the second recording layer is a value corresponding to the characteristic of the optical system, and a fourth focus offset when a difference between the focus offset and the learned focus offset for the third recording layer is a value corresponding to the characteristic of the optical system, from the learned focus offset for the second recording layer and the learned focus offset for the third recording layer,
calculates a fifth focus offset as a mean value of the calculated second focus offset and third focus offset, or calculates a sixth focus offset when a difference between the focus offset and the both focus offsets is a value corresponding to the characteristic of the optical system, from the calculated second focus offset and third focus offset, and
sets the first focus offset with respect to the first recording layer sets the fifth focus offset or the six focus offset with respect to the second recording layer, and sets the fourth focus offset with respect to the third recording layer as focus offsets for recording or reproduction.

3. An optical disc apparatus capable of information recording or reproduction with respect to an optical disc having a plurality of recording layers, comprising:
an optical system which collects laser light and emits the laser light on the recording layer;
a first control module which, regarding each of mutually adjacent recording layers in the optical disc, learns a focus offset for the optical system with respect to a guide groove formed in a recording surface of each of the recording layers from a signal based on reflected light from the guide groove; and
a second control module which calculates and sets a focus offset for the optical system for recording or reproduction based on the focus offsets for the respective recording layers learned by the first control module,
wherein, when the first recording layer, the second recording layer and the third recording layer, are arranged from the optical system side as the plurality of recording layers in the optical disc,
the second control module
calculates a first focus offset when a difference between the focus offset and the learned focus offset for the first recording layer is a value corresponding to a characteristic of the optical system, and sets the calculated first focus offset as a focus offset for recording or reproduction for the first recording layer, from the learned focus offset for the first recording layer and the learned focus offset for the second recording layer,
calculates a second focus offset when a difference between the focus offset and the learned focus offset for the second recording layer is a value corresponding to the characteristic of the optical system, and a third focus offset when a difference between the focus offset and the learned focus offset for the third recording layer is a value corresponding to the characteristic of the optical system, from the learned focus offset for the second recording layer and the learned focus offset for the third recording layer, and
sets the calculated second focus offset as a focus offset for recording or reproduction for the second recording layer, and sets the calculated third focus offset as a focus offset for recording or reproduction for the third recording layer.

4. The optical disc apparatus according to claim 2, wherein, assuming that the focus offset for the first recording layer of the adjacent recording layers learned by the first control module is F_{A0}, the focus offset for the second recording layer is F_{A1}, the focus offset for the third recording layer is F_{A2}, the focus offset calculated and set by the second control module as a focus offset for recording or reproduction for the first recording layer is F_{Q0}, the focus offset calculated and set as a focus offset for recording or reproduction for the second recording layer is F_{Q1c}, and the focus offset calculated and set as a focus offset for recording or reproduction for the third recording layer is F_{Q2},
the second control module calculates and sets the focus offsets F_{Q0}, F_{Q1c} and F_{Q2} by
F_{Q0}=(3×F_{A0}+F_{A1})/4
F_{Q1c}={(F_{A0}+3×F_{A1})/4+(3×F_{A1}+F_{A2})/4}/2
F_{Q2}=(F_{A1}+3×F_{A2})/4.

5. The optical disc apparatus according to claim 3, wherein, assuming that the focus offset for the first recording layer of the adjacent recording layers learned by the first control module is F_{A0}, the focus offset for the second recording layer is F_{A1}, the focus offset for the third recording layer is F_{A2}, the focus offset calculated and set by the second control module as a focus offset for recording or reproduction for the first recording layer is F_{Q0}, the focus offset calculated and set as a focus offset for recording or reproduction for the second recording layer is F_{Q1b}, and the focus offset calculated and set as a focus offset for recording or reproduction for the third recording layer is F_{Q2},
the second control module calculates and sets the focus offsets F_{Q0}, F_{Q1b} and F_{Q2} by
F_{Q0}=(3×F_{A0}+F_{A1})/4
F_{Q1b}=(3×F_{A1}+F_{A2})/4
F_{Q2}=(F_{A1}+3×F_{A2})/4.

6. An optical disc apparatus capable of information recording or reproduction with respect to an optical disc having a plurality of recording layers, comprising:
an optical system which collects laser light and emits the laser light on the recording layer;
a temperature detection module which detects a temperature in the optical disc apparatus; and
a control module which, regarding each of mutually adjacent recording layers in the optical disc, learns a focus offset for the optical system with respect to a guide groove formed in a recording surface of each of the recording layers from a signal based on reflected light from the guide groove, then calculates and sets a focus offset for the optical system for recording or reproduction based on the learned focus offsets for the respective recording layers and temperature information detected by the temperature detection module.

7. An optical disc apparatus capable of information recording or reproduction with respect to an optical disc having a plurality of recording layers, comprising:
an optical system which collects laser light and emits the laser light on the recording layer;
a temperature detection module which detects a temperature in the optical disc apparatus;
a first control module which, regarding each of mutually adjacent recording layers in the optical disc, learns a focus offset for the optical system with respect to a guide groove formed in a recording surface of each of the recording layers from a signal based on reflected light from the guide groove; and
a second control module which calculates and sets a focus offset for the optical system for recording or reproduction based on the focus offsets for the respective recording layers learned by the first control module and temperature information detected by the temperature detection module.

8. The optical disc apparatus according to claim 7, wherein the first control module uses a push-pull signal or a wobble signal as the signal based on the reflected light, and learns a focus offset when an amplitude of the push-pull signal or the wobble signal is in a maximum range as a focus offset for the respective guide grooves.

9. The optical disc apparatus according to claim 7, wherein when the temperature detected by the temperature detection module is a relatively low first temperature, the second control module calculates a mean value of the focus offsets for the respective recording layers learned by the first control module, and when the temperature detected by the temperature detection module is a relatively high second temperature, the second control module calculates a focus offset when a difference between the focus offset and the focus offsets for the respective recording layers learned by the first control module is different and sets the calculated focus offset as a focus offset for the optical system for recording or reproduction common to the both recording layers, otherwise, calculates a focus offset when a difference between the focus offset and the focus offsets for the respective recording layers learned by the first control module is a value corresponding to the characteristic of the optical system and sets the calculated focus offset as a focus offset for the optical system for recording or reproduction for the respective recording layers.

10. The optical disc apparatus according to claim 9, wherein assuming that the focus offset for a first recording layer of the adjacent recording layers learned by the first control module is F_{A0}, the focus offset for a second recording layer is F_{A1}, the focus offset calculated and set by the second control module as a focus offset for recording or reproduction for the first recording layer is F_{Q0}, and the focus offset calculated and set as a focus offset for recording or reproduction for the second recording layer is F_{Q1},
when the first temperature is within a range from 0° C. to 25° C., the second control module calculates the focus offsets F_{Q0} and F_{Q1} by
F_{Q0}=F_{Q1}=(F_{A0}+F_{A1})/2,
and when the second temperature is within a range from 50° C. to 65° C., the second control module calculates the focus offsets F_{Q0} and F_{Q1} by
F_{Q0}=(3×F_{A0}+F_{A1})/4
F_{Q1}=(F_{A0}+3×F_{A1})/4.

11. A focus offset setting method for an optical disc apparatus capable of information recording or reproduction by collecting laser light and emitting the laser light by an optical system with respect to an optical disc having a plurality of recording layers, comprising:
a first step of, regarding each of mutually adjacent recording layers in the optical disc, learning a focus offset for the optical system with respect to a guide groove, formed in a recording surface of each of the recording layers, from a signal based on reflected light from the guide groove, and detecting a temperature in the optical disc apparatus; and
a second step of calculating and setting a focus offset for the optical system for recording or reproduction based on the learned respective focus offsets and the detected temperature information.

12. The focus offset setting method for the optical disc apparatus according to claim 11, wherein when the detected temperature in the apparatus is a relatively low first temperature, at the second step, a mean value of the focus offsets for the respective recording layers learned at the first step is calculated, and the mean value is set as a common focus offset to the both recording layers for recording or reproduction.

13. The focus offset setting method for the optical disc apparatus according to claim 11, wherein when the detected temperature in the apparatus is a relatively high second temperature, at the second step, a focus offset when a difference between the focus offset and the focus offsets for the respective recording layers learned at the first step is a value corresponding to the characteristic of the optical system is calculated, and the calculated focus offset is set as a focus offset for the optical system for recording or reproduction for the respective recording layers.
